(19) United States
(12) Patent Application Publication
(10) Pub. No.: US 2026/0019983 A1
(43) Pub. Date: Jan. 15, 2026

(54) BANDWIDTH AGGREGATION FOR POSITIONING ENHANCEMENT

(71) Applicant: Intel Corporation, Santa Clara, CA (US)

(72) Inventors: Gang Xiong, Beaverton, OR (US); Debdeep Chatterjee, San Jose, CA (US); Seunghee Han, San Jose, CA (US); Toufiqul Islam, Santa Clara, CA (US); Kilian Peter Anton Roth, München (DE); Jihyun Lee, Santa Clara, CA (US)

(21) Appl. No.: 19/145,101

(22) PCT Filed: Dec. 5, 2023
(86) PCT No.: PCT/US2023/082459

§ 371 Date: Jul. 1, 2025

Related U.S. Application Data
(60) Provisional application No. 63/482,687, filed on Feb. 1, 2023.
(60) Provisional application No. 63/486,923, filed on Feb. 24, 2023.
(60) Provisional application No. 63/494,712, filed on Apr. 6, 2023.

(51) Int. Cl. H04W 64/00; H04L 5/00; H04W 72/0446; H04W 72/232

(52) U.S. Cl. CPC H04W 64/00; H04L 5/005; H04W 72/0446; H04W 72/232

(57) ABSTRACT

A computer-readable storage medium stores instructions for execution by one or more processors of a UE and to configure the UE for positioning enhancements in a 5GNR and beyond network, and cause the UE to encode RRC signaling for transmission to a base station. The RRC signaling includes UE capability information, indicating the UE supports one or both of DL PRS bandwidth aggregation and UL SRS for positioning bandwidth aggregation. Higher layer configuration via RRC signaling is received from the base station and configures a linkage between DL PRS resource sets across two or more DL PFLs that are mapped to two or more contiguous intra-band DL component carriers for DL PRS bandwidth aggregation operation. The UE performs measurements using the DL PRS resource sets across the configured intra-band DL component carriers in accordance with the linkage.

### PRIORITY CLAIM

This application claims the benefit of priority to the following provisional applications:
U.S. Provisional Patent Application No. 63/482,687, filed Feb. 1, 2023, and entitled “BANDWIDTH AGGREGATION FOR POSITIONING ENHANCEMENT;”
U.S. Provisional Patent Application No. 63/486,923, filed Feb. 24, 2023, and entitled “BANDWIDTH AGGREGATION FOR POSITIONING ENHANCEMENT;” and
U.S. Provisional Patent Application No. 63/494,712, filed Apr. 6, 2023, and entitled “BANDWIDTH AGGREGATION FOR POSITIONING ENHANCEMENT.”

Each of the above-listed provisional applications is incorporated herein by reference in its entirety.

### BACKGROUND

Mobile communications have evolved significantly from early voice systems to today's highly sophisticated integrated communication platform. With the increase in different types of devices communicating with various network devices, the usage of 3GPP LTE systems has increased. The penetration of mobile devices (user equipment or UEs) in modern society has continued to drive demand for a wide variety of networked devices in many disparate environments. Fifth-generation (5G) wireless systems are forthcoming and are expected to enable even greater speed, connectivity, and usability. Next-generation 5G networks (or NR networks) and beyond (e.g., 6G networks) are expected to increase throughput, coverage, and robustness and reduce latency and operational and capital expenditures. 5G NR (and beyond) networks will continue to evolve based on 3GPP LTE-Advanced with additional potential new radio access technologies (RATs) to enrich people's lives with seamless wireless connectivity solutions, delivering fast, rich content and services. As the current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC) or DC-based LAA and the standalone LTE system in the unlicensed spectrum, according to which LTE-based technology solely operates in the unlicensed spectrum without requiring an “anchor” in the licensed spectrum, called MulteFire. Further enhanced operation of LTE and NR systems in the licensed, as well as unlicensed spectrum is expected in future releases and 5G and beyond systems. Such enhanced operations can include techniques for bandwidth aggregation for positioning enhancement.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates the architecture of a network, in accordance with some aspects.

FIG. 1B and FIG. 1C illustrate a non-roaming 5G system architecture in accordance with some aspects.

FIG. 2, FIG. 3, and FIG. 4 illustrate various systems, devices, and components that may implement aspects of disclosed embodiments.

FIG. 5 illustrates bandwidth aggregation for sounding reference signal (SRS) transmission across intra-band contiguous carriers, in accordance with some aspects.

FIG. 6 illustrates downlink provisioning reference signal (DL PRS) transmission with bandwidth aggregation, in accordance with some aspects.

FIG. 7 illustrates the same SRS resource configuration across intra-band contiguous carriers, in accordance with some aspects.

FIG. 8 illustrates MAC-CE with activation and deactivation of semi-persistent SRS for positioning with bandwidth aggregation, in accordance with some aspects.

FIG. 9 illustrates phase continuity and/or power consistency for simultaneous transmission of SRSs, in accordance with some aspects.

FIG. 10 illustrates a block diagram of a communication device such as an evolved Node-B (eNB), a new generation Node-B (gNB) (or another RAN node), an NCR, an access point (AP), a wireless station (STA), a mobile station (MS), or user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for those of other aspects. Aspects outlined in the claims encompass all available equivalents of those claims.

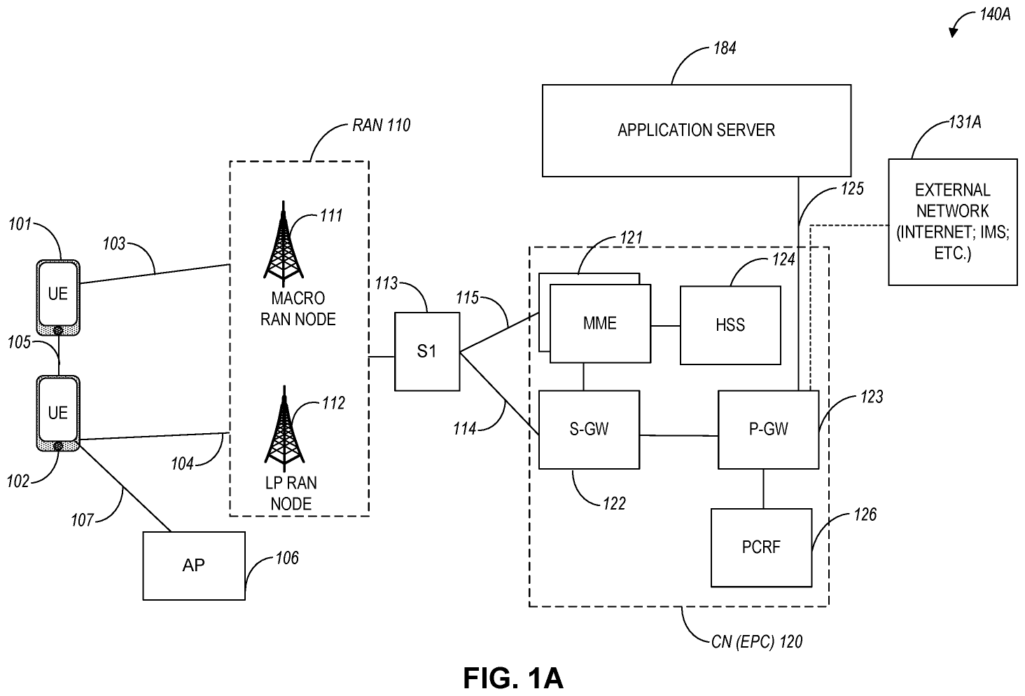

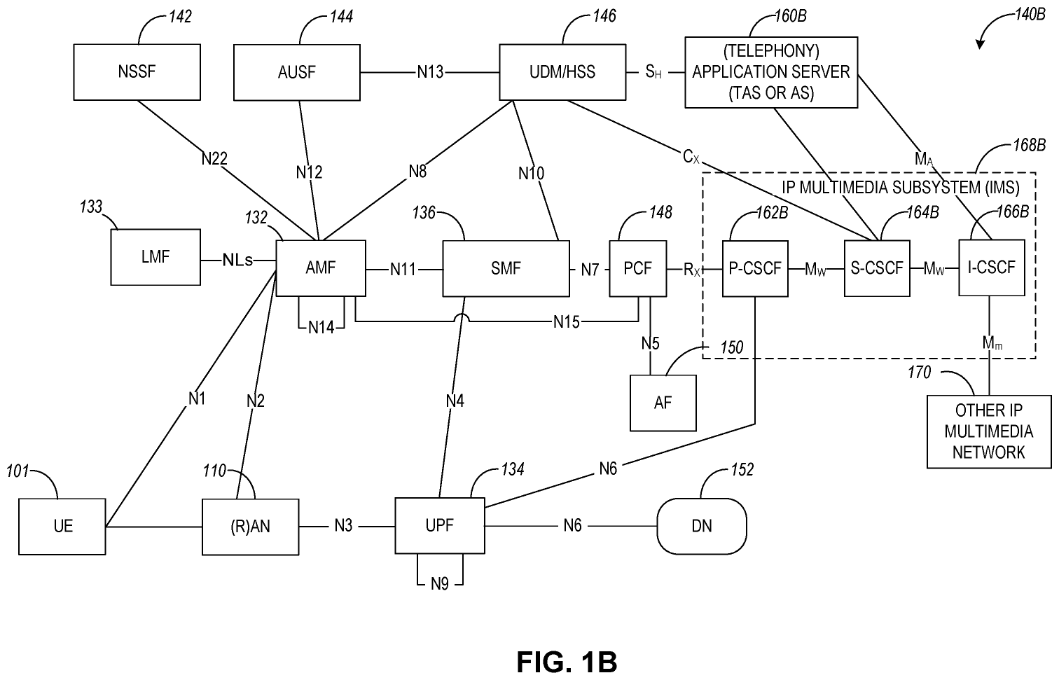

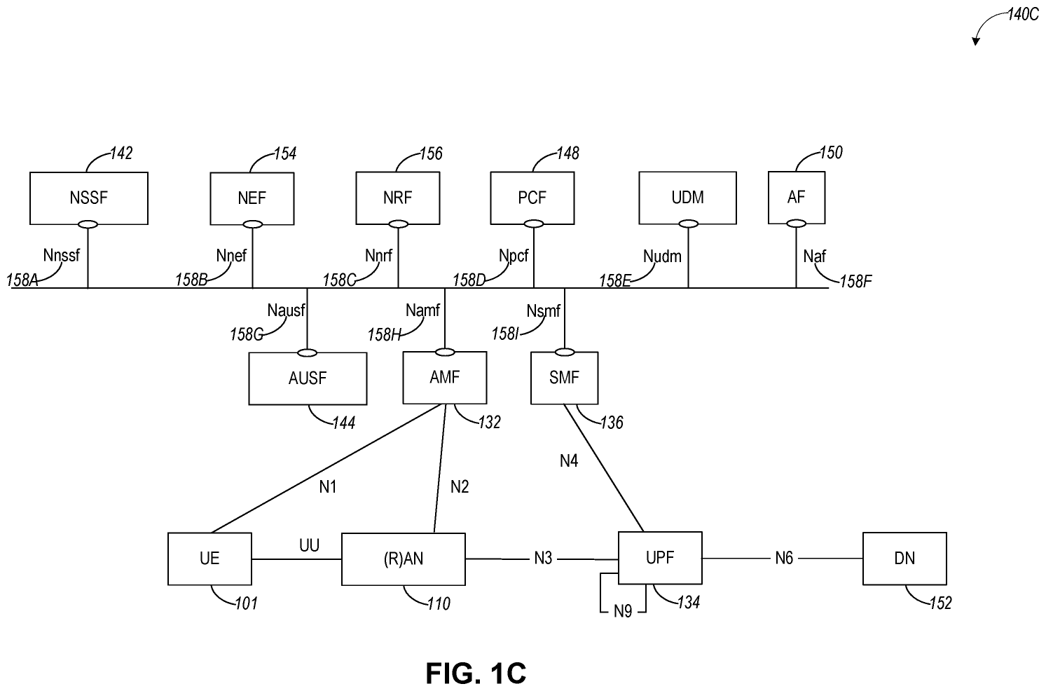

FIGS. 1A-10 illustrate various systems, devices, and components that may implement aspects of disclosed embodiments in different communication systems, such as 5G-NR (and beyond) networks. UEs, base stations (such as gNBs), and/or other nodes (e.g., satellites or other computing nodes) discussed herein can be configured to perform the disclosed techniques.

FIG. 1A illustrates the architecture of a network in accordance with some aspects. The communication network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. UE 101 and UE 102 can be collectively referred to herein as UE 101, and UE 101 can be used to perform one or more of the techniques disclosed herein.

Any of the radio links described herein (e.g., as used in the communication network 140A or any other illustrated network) may operate according to any exemplary radio communication technology and/or standard.

LTE and LTE-Advanced are standards for wireless communications of high-speed data for UE, such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme, including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHZ and further frequencies).

Aspects described herein can also be applied to different Single Carrier or OFDM flavors (CP-OFDM, SC-FDMA, SC-OFDM, filter bank-based multicarrier (FBMC), OFDMA, etc.) and, in particular, 3GPP NR (New Radio) by allocating the OFDM carrier data bit vectors to the corresponding symbol resources.

In some aspects, any of the UE 101 and UE 102 can comprise an Internet-of-Things (IoT) UE or a Cellular IoT (CIOT) UE, which can comprise a network access layer designed for low-power IoT applications utilizing short-lived UE connections. In some aspects, any of the UE 101 and UE 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure) with short-lived connections. The IoT UEs may execute background applications (e.g., keep-alive messages, status updates, etc.) to facilitate the connections of the IoT network.

In some aspects, any of the UE 101 and UE 102 can include enhanced MTC (eMTC) UEs or further enhanced MTC (FeMTC) UEs.

The UE 101 and UE 102 may be configured to connect, e.g., communicatively coupled, with a radio access network (RAN) 110. The RAN 110 may be, for example, a Universal Mobile Telecommunications System (UMTS), an Evolved Universal Terrestrial Radio Access Network (E-UTRAN), a NextGen RAN (NG RAN), or some other type of RAN. The UE 101 and UE 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN network nodes, and the like, and can comprise ground stations (e.g., terrestrial access points) or satellite stations providing coverage within a geographic area (e.g., a cell). In some aspects, communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN nodes, and one or more RAN nodes for providing femtocells or picocells (e.g., cells having smaller coverage areas, smaller user capacity, or higher bandwidth compared to macrocells), e.g., low power (LP) RAN node or an unlicensed spectrum based secondary RAN node.

Any of the communication nodes 111 and 112 can terminate the air interface protocol and can be the first point of contact for UE 101 and UE 102. In some aspects, any of the communication nodes 111 and 112 can fulfill various logical functions for the RAN 110, including, but not limited to, the radio network controller (RNC) functions such as radio bearer management, uplink, and downlink dynamic radio resource management, and data packet scheduling, and mobility management. In an example, any of the communication nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in FIGS. 1B-1C). In this aspect, the S1 interface 113 is split into two parts: the S1-U interface 114, which carries user traffic data between the communication nodes 111 and 112 and the serving gateway (S-GW) 122, and the S1-mobility management entity (MME) interface 115, which is a signaling interface between the communication nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access, such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the S1 interface 113 towards the RAN 110 and route data packets between the RAN 110 and the CN 120. In addition, the S-GW 122 may be a local mobility anchor point for inter-RAN node handovers and may also provide an anchor for inter-3GPP mobility. Other responsibilities of the S-GW 122 may include lawful intercept, charging, and some policy enforcement.

The P-GW 123 may terminate an SGi interface toward a PDN. The P-GW 123 may route data packets between the EPC network (e.g., CN 120) and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including a 5G new radio network using communications in the licensed (5G NR) and the unlicensed (5G NR-U) spectrum. One of the current enablers of IoT is the narrowband IoT (NB-IoT).

An NG system architecture can include the RAN 110 and a 5G core network (e.g., CN 120). RAN 110 in an NG system can be referred to as NG-RAN. The RAN 110 can include a plurality of nodes, such as gNBs and NG-eNBs. The CN 120 (also referred to as a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces and the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, a RAN network node, and so forth. In some aspects, a gNB can be a master node (MN), and NG-eNB can be a secondary node (SN) in a 5G architecture. In some aspects, the master/primary node may operate in a licensed band, and the secondary node may operate in an unlicensed band.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, location management function (LMF) 133, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The LMF 133 may be used in connection with 5G positioning functionalities. In some aspects, LMF 133 receives measurements and assistance information from the RAN 110 and the mobile device (e.g., UE 101) via the AMF 132 over the NLs interface to compute the position of the UE 101. In some aspects, NR positioning protocol A (NRPPa) may be used to carry the positioning information between NG-RAN and LMF 133 over a next-generation control plane interface (NG-C). In some aspects, LMF 133 configures the UE using the LTE positioning protocol (LPP) via AMF 132. The RAN 110 configures the UE 101 using radio resource control (RRC) protocol over LTE-Uu and NR-Uu interfaces.

In some aspects, the 5G system architecture 140B configures different reference signals to enable positioning measurements. Example reference signals that may be used for positioning measurements include the positioning reference signal (NR PRS) in the downlink and the sounding reference signal (SRS) for positioning in the uplink. The downlink positioning reference signal (PRS) is a reference signal configured to support downlink-based positioning methods.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IMS 168B. The S-CSCF 164B can be configured to handle the session states in the network, and the E-CSCF can be configured to handle certain aspects of emergency sessions, such as routing an emergency request to the correct emergency center or PSAP. The I-CSCF 166B can be configured to function as the contact point within an operator's network for all IMS connections destined to a subscriber of that network operator or a roaming subscriber currently located within that network operator's service area. In some aspects, the I-CSCF 166B can be connected to another IP multimedia network 170, e.g., an IMS operated by a different network operator.

In some aspects, the UDM/HSS 146 can be coupled to an application server (AS) 160B, which can include a telephony application server (TAS) or another AS. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, the 5G system architecture 140C can also include a network exposure function (NEF) 154 and a network repository function (NRF) 156. In some aspects, 5G system architectures can be service-based, and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

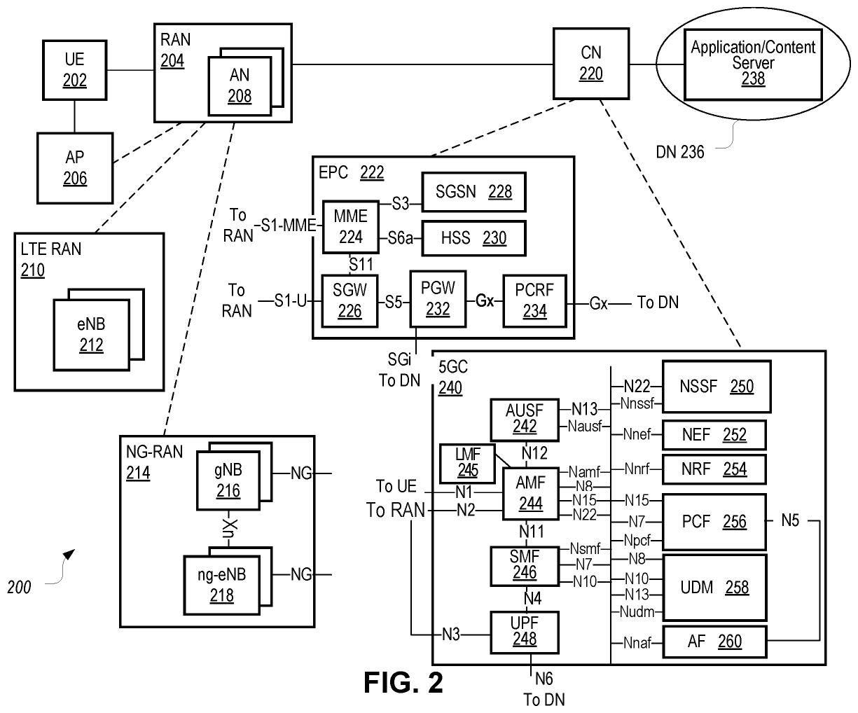

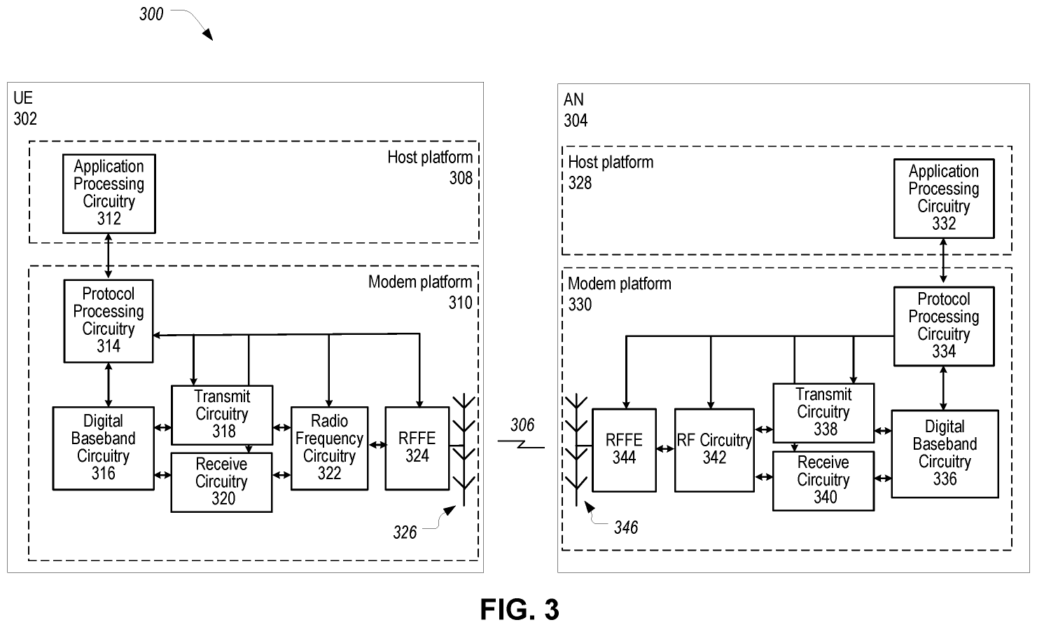

FIG. 2 illustrates a network 200 in accordance with various embodiments. The network 200 may operate in a manner consistent with 3GPP technical specifications for LTE or 5G/NR systems. However, the example embodiments are not limited in this regard, and the described embodiments may apply to other networks that benefit from the principles described herein, such as future 3GPP systems or the like.

The network 200 may include a UE 202, which may include any mobile or non-mobile computing device designed to communicate with a RAN 204 via an over-the-air connection. The UE 202 may be, but is not limited to, a smartphone, tablet computer, wearable computing device, desktop computer, laptop computer, in-vehicle infotainment, in-car entertainment device, instrument cluster, a head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, network 200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 202 may additionally communicate with an AP 206 via an over-the-air connection. The AP 206 may manage a WLAN connection, which may serve to offload some/all network traffic from the RAN 204. The connection between the UE 202 and the AP 206 may be consistent with any IEEE 802.11 protocol, wherein the AP 206 could be a wireless fidelity (Wi-Fi®) router. In some embodiments, the UE 202, RAN 204, and AP 206 may utilize cellular-WLAN aggregation (for example, LWA/LWIP). Cellular-WLAN aggregation may involve the UE 202 configured by the RAN 204 to utilize both cellular radio resources and WLAN resources.

The RAN 204 may include one or more access nodes, for example, access node (AN) 208. AN 208 may terminate air-interface protocols for the UE 202 by providing access stratum protocols, including RRC, Packet Data Convergence Protocol (PDCP), Radio Link Control (RLC), MAC, and L1 protocols. In this manner, the AN 208 may enable data/voice connectivity between the core network (CN) 220 and the UE 202. In some embodiments, the AN 208 may be implemented in a discrete device or as one or more software entities running on server computers as part of, for example, a virtual network, which may be referred to as a CRAN or virtual baseband unit pool. The AN 208 can be referred to as a BS, gNB, RAN node, eNB, ng-eNB, NodeB, RSU, TRxP, TRP, etc. The AN 208 may be a macrocell base station or a low-power base station for providing femtocells, picocells, or other like cells having smaller coverage areas, smaller user capacity, or higher bandwidth compared to macrocells.

In embodiments in which the RAN 204 includes a plurality of ANs, they may be coupled with one another via an X2 interface (if the RAN 204 is an LTE RAN) or an Xn interface (if the RAN 204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 204 may each manage one or more cells, cell groups, component carriers, etc., to provide the UE 202 with an air interface for network access. The UE 202 may be simultaneously connected with a plurality of cells provided by the same or different ANs of the RAN 204. For example, the UE 202 and RAN 204 may use carrier aggregation to allow the UE 202 to connect with a plurality of component carriers, each corresponding to a Pcell or Scell. In dual connectivity scenarios, a first AN may be a master node that provides an MCG, and a second AN may be a secondary node that provides an SCG. The first/second ANs may be any combination of eNB, gNB, ng-eNB, etc.

The RAN 204 may provide the air interface over a licensed spectrum or an unlicensed spectrum. To operate in the unlicensed spectrum, the nodes may use LAA, eLAA, and/or feLAA mechanisms based on CA technology with PCells/SCells. Before accessing the unlicensed spectrum, the nodes may perform medium/carrier-sensing operations based on, for example, a listen-before-talk (LBT) protocol.

In V2X scenarios, the UE 202 or AN 208 may be or act as a roadside unit (RSU), which may refer to any transportation infrastructure entity used for V2X communications. An RSU may be implemented in or by a suitable AN or a stationary (or relatively stationary) UE. An RSU implemented in or by a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, and media, as well as applications/software to sense and control ongoing vehicular and pedestrian traffic. The RSU may provide very low latency communications required for high-speed events, such as crash avoidance, traffic warnings, and the like. Additionally, or alternatively, the RSU may provide other cellular/WLAN communications services. The components of the RSU may be packaged in a weatherproof enclosure suitable for outdoor installation and may include a network interface controller to provide a wired connection (e.g., Ethernet) to a traffic signal controller or a backhaul network.

In some embodiments, the RAN 204 may be an LTE RAN 210 with eNBs, for example, eNB 212. The LTE RAN 210 may provide an LTE air interface with the following characteristics: sub-carrier spacing (SCS) of 15 kHz; CP-OFDM waveform for downlink (DL) and SC-FDMA waveform for uplink (UL); turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 204 may be an NG-RAN 214 with gNBs, for example, gNB 216, or ng-eNBs, for example, ng-eNB 218. The gNB 216 may connect with 5G-enabled UEs using a 5G NR interface. The gNB 216 may connect with a 5G core through an NG interface, which may include an N2 interface or an N3 interface. The ng-eNB 218 may also connect with the 5G core through an NG interface but may connect with a UE via an LTE air interface. The gNB 216 and the ng-eNB 218 may connect over an Xn interface.

In some embodiments, the NG interface may be split into two parts: an NG user plane (NG-U) interface, which carries traffic data between the nodes of the NG-RAN 214 and a UPF 248 (e.g., N3 interface), and an NG control plane (NG-C) interface, which is a signaling interface between the nodes of the NG-RAN 214 and an AMF 244 (e.g., N2 interface).

The NG-RAN 214 may provide a 5G-NR air interface with the following characteristics: variable SCS; CP-OFDM for DL, CP-OFDM, and DFT-s-OFDM for UL; polar, repetition, simplex, and Reed-Muller codes for control and LDPC for data. The 5G-NR air interface may rely on CSI-RS and PDSCH/PDCCH DMRS, similar to the LTE air interface. The 5G-NR air interface may not use a CRS but may use PBCH DMRS for PBCH demodulation, PTRS for phase tracking for PDSCH, and tracking reference signal for time tracking. The 5G-NR air interface may operate on FRI bands that include sub-6 GHz bands or FR2 bands that include bands from 24.25 GHz to 52.6 GHz. The 5G-NR air interface may include a synchronization signal and physical broadcast channel (SS/PBCH) block (SSB), which is an area of a downlink resource grid that includes PSS/SSS/PBCH.

In some embodiments, the 5G-NR air interface may utilize BWPs (bandwidth parts) for various purposes. For example, BWP can be used for dynamic adaptation of the SCS. For example, the UE 202 can be configured with multiple BWPs where each BWP configuration has a different SCS. When a BWP change is indicated to the UE 202, the SCS of the transmission is changed as well. Another use case example of BWP is related to power saving. In particular, multiple BWPs can be configured for the UE 202 with different amounts of frequency resources (for example, PRBs) to support data transmission under different traffic loading scenarios. A BWP containing a smaller number of PRBs can be used for data transmission with a small traffic load while allowing power saving at the UE 202 and, in some cases, at the gNB 216. A BWP containing a larger number of PRBs can be used for scenarios with higher traffic loads.

The RAN 204 is communicatively coupled to CN 220, which includes network elements to provide various functions to support data and telecommunications services to customers/subscribers (for example, users of UE 202). The components of the CN 220 may be implemented in one physical node or separate physical nodes. In some embodiments, NFV may be utilized to virtualize any or all of the functions provided by the network elements of the CN 220 onto physical compute/storage resources in servers, switches, etc. A logical instantiation of the CN 220 may be referred to as a network slice, and a logical instantiation of a portion of the CN 220 may be referred to as a network sub-slice.

In some embodiments, the CN 220 may be connected to the LTE radio network as part of the Enhanced Packet System (EPS) 222, which may also be referred to as an EPC (or enhanced packet core). The EPC 222 may include MME 224, SGW 226, SGSN 228, HSS 230, PGW 232, and PCRF 234 coupled with one another over interfaces (or “reference points”) as shown. Functions of the elements of the EPC 222 may be briefly introduced as follows.

The MME 224 may implement mobility management functions to track the current location of the UE 202 to facilitate paging, bearer activation/deactivation, handovers, gateway selection, authentication, etc.

The SGW 226 may terminate an S1 interface toward the RAN and route data packets between the RAN and the EPC 222. The SGW 226 may be a local mobility anchor point for inter-RAN node handovers and may also provide an anchor for inter-3GPP mobility. Other responsibilities may include lawful intercept, charging, and some policy enforcement.

The SGSN 228 may track the location of the UE 202 and perform security functions and access control. In addition, the SGSN 228 may perform inter-EPC node signaling for mobility between different RAT networks, PDN and S-GW selection as specified by MME 224, MME selection for handovers, etc. The S3 reference point between the MME 224 and the SGSN 228 may enable user and bearer information exchange for inter-3GPP access network mobility in idle/active states.

The HSS 230 may include a database for network users, including subscription-related information to support the network entities' handling of communication sessions. The HSS 230 can provide support for routing/roaming, authentication, authorization, naming/addressing resolution, location 20) dependencies, etc. An S6a reference point between the HSS 230 and the MME 224 may enable the transfer of subscription and authentication data for authenticating/authorizing user access to the LTE CN (e.g., CN 220).

The PGW 232 may terminate an SGi interface toward a data network (DN) 236 that may include an application/content server 238. The PGW 232 may route data packets between the LTE CN and the data network 236. The PGW 232 may be coupled with the SGW 226 by an S5 reference point to facilitate user plane tunneling and tunnel management. The PGW 232 may further include a node for policy enforcement and charging data collection (for example, PCEF). Additionally, the SGi reference point between the PGW 232 and the data network 236 may be an operator external public, a private PDN, or an intra-operator packet data network, for example, for the provision of IMS services. The PGW 232 may be coupled with a PCRF 234 via a Gx reference point.

The PCRF 234 is the policy and charging control element of the CN 220. The PCRF 234 may be communicatively coupled to the app/content server 238 to determine the appropriate quality of service and charging parameters for service flows. The PCRF 234 may provision associated rules into a PCEF (via Gx reference point) with appropriate TFT and QCI.

In some embodiments, the CN 220 may be a 5GC 240. The 5GC 240 may include an AUSF 242, AMF 244, SMF 246, UPF 248, NSSF 250, NEF 252, NRF 254, PCF 256, UDM 258, and AF 260 coupled with one another over interfaces (or “reference points”) as shown. Functions of the elements of the 5GC 240 may be briefly introduced as follows.

The AUSF 242 may store data for the authentication of UE 202 and handle authentication-related functionality. The AUSF 242 may facilitate a common authentication framework for various access types. In addition to communicating with other elements of the 5GC 240 over reference points, as shown, the AUSF 242 may exhibit a Nausf service-based interface.

The AMF 244 may allow other functions of the 5GC 240 to communicate with the UE 202 and the RAN 204 and to subscribe to notifications about mobility events with respect to the UE 202. The AMF 244 may be responsible for registration management (for example, for registering UE 20) 202), connection management, reachability management, mobility management, lawful interception of AMF-related events, and access authentication and authorization. The AMF 244 may provide transport for SM messages between the UE 202 and the SMF 246 and act as a transparent proxy for routing SM messages. AMF 244 may also provide transport for SMS messages between UE 202 and an SMSF. AMF 244 may interact with the AUSF 242 and the UE 202 to perform various security anchor and context management functions. Furthermore, AMF 244 may be a termination point of a RAN CP interface, which may include or be an N2 reference point between the RAN 204 and the AMF 244, and the AMF 244 may be a termination point of NAS (N1) signaling, and perform NAS ciphering and integrity protection. AMF 244 may also support NAS signaling with the UE 202 over an N3 IWF interface.

The SMF 246 may be responsible for SM (for example, session establishment, tunnel management between UPF 248 and AN 208); UE IP address allocation and management (including optional authorization); selection and control of UP function; configuring traffic steering at UPF 248 to route traffic to proper destination; termination of interfaces toward policy control functions; controlling part of policy enforcement, charging, and quality of service; lawful intercept (for SM events and interface to LI system); termination of SM parts of NAS messages; downlink data notification; initiating AN specific SM information, sent via AMF 244 over N2 to AN 208; and determining SSC mode of a session. SM may refer to the management of a PDU session, and a PDU session or “session” may refer to a PDU connectivity service that provides or enables the exchange of PDUs between the UE 202 and the data network 236.

The UPF 248 may act as an anchor point for intra-RAT and inter-RAT mobility, an external PDU session point of interconnecting to data network 236, and a branching point to support multi-homed PDU sessions. The UPF 248 may also perform packet routing and forwarding, perform packet inspection, enforce the user plane part of policy rules, lawfully intercept packets (UP collection), perform traffic usage reporting, perform quality of service handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 248 may include an uplink classifier to support routing traffic flows to a data network.

The NSSF 250 may select a set of network slice instances serving the UE 202. The NSSF 250 may also determine allowed NSSAI and the mapping to the subscribed S-NSSAIs if needed. The NSSF 250 may also determine the AMF set to be used to serve the UE 202 or a list of candidate AMFs based on a suitable configuration and possibly by querying the NRF 254. The selection of a set of network slice instances for the UE 202 may be triggered by the AMF 244, with which the UE 202 is registered by interacting with the NSSF 250, which may lead to a change of AMF. The NSSF 250 may interact with the AMF 244 via an N22 reference point and may communicate with another NSSF in a visited network via an N31 reference point (not shown). Additionally, the NSSF 250 may exhibit an Nnssf service-based interface.

The NEF 252 may securely expose services and capabilities provided by 3GPP network functions for the third party, internal exposure/re-exposure, AFs (e.g., AF 260), edge computing or fog computing systems, etc. In such embodiments, the NEF 252 may authenticate, authorize, or throttle the AFs.

NEF 252 may also translate information exchanged with the AF 260 and information exchanged with internal network functions. For example, the NEF 252 may translate between an AF-Service-Identifier and an internal 5GC information. NEF 252 may also receive information from other NFs based on the exposed capabilities of other NFs. This information may be stored at the NEF 252 as structured data or a data storage NF using standardized interfaces. The stored information can then be re-exposed by the NEF 252 to other NFs and AFs or used for other purposes, such as analytics. Additionally, the NEF 252 may exhibit a Nnef service-based interface.

The NRF 254 may support service discovery functions, receive NF discovery requests from NF instances, and provide information on the discovered NF instances to the NF instances. NRF 254 also maintains information on available NF instances and their supported services. As used herein, the terms “instantiate,” “instantiation,” and the like may refer to the creation of an instance, and an “instance” may refer to a concrete occurrence of an object, which may occur, for example, during the execution of program code. Additionally, the NRF 254 may exhibit the Nnrf service-based interface.

The PCF 256 may provide policy rules to control plane functions to enforce them and may also support a unified policy framework to govern network behavior. The PCF 256 may also implement a front end to access subscription information relevant to policy decisions in a UDR of the UDM 258. In addition to communicating with functions over reference points, as shown, the PCF 256 exhibits an Npcf service-based interface.

The UDM 258 may handle subscription-related information to support the network entities' handling of communication sessions and may store the subscription data of UE 202. For example, subscription data may be communicated via an N8 reference point between the UDM 258 and the AMF 244. The UDM 258 may include two parts: an application front end and a UDR. The UDR may store subscription data and policy data for the UDM 258 and the PCF 256, and/or structured data for exposure and application data (including PFDs for application detection and application request information for multiple UE) for the NEF 252. The UDR may exhibit the Nudr service-based interface to allow the UDM 258, PCF 256, and NEF 252 to access a particular set of the stored data, as well as to read, update (e.g., add, modify), delete, and subscribe to the notification of relevant data changes in the UDR. The UDM may include a UDM-FE, which is in charge of processing credentials, location management, subscription management, and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points, as shown, the UDM 258 may exhibit the Nudm service-based interface.

The AF 260 may provide application influence on traffic routing, provide access to NEF, and interact with the policy framework for policy control.

In some embodiments, the 5GC 240 may enable edge computing by selecting operator/3rd party services to be geographically close to a point that the UE 202 is attached to the network. This may reduce latency and load on the network. To provide edge-computing implementations, the 5GC 240 may select a UPF 248 close to the UE 202 and execute traffic steering from the UPF 248 to data network 236 via the N6 interface. This may be based on the UE subscription data, UE location, and information provided by the AF 260. In this way, the AF 260 may influence UPF (re) selection and traffic routing. Based on operator deployment, when AF 260 is considered to be a trusted entity, the network operator may permit AF 260 to interact directly with relevant NFs. Additionally, the AF 260 may exhibit a Naf service-based interface.

The data network 236 may represent various network operator services, Internet access, or third-party services that may be provided by one or more servers, including, for example, application/content server 238.

In some aspects, network 200 is configured for NR positioning using the location management function (LMF) 245, which can be configured as an LMF node or as functionality in a different type of node. In some embodiments, LMF 245 is configured to receive measurements and assistance information from NG-RAN 214 and UE 202 via the AMF 244 (e.g., using an NLs interface) to compute the position of the UE. In some embodiments, the NR positioning protocol A (NRPPa) can be used to carry the positioning information between NG-RAN 214 and LMF 245 over a next-generation control plane interface (NG-C). In some embodiments, LMF 245 configures the UE 202 using LTE positioning protocol (LPP) (e.g., LPP-based communication link) via the AMF 244. In some aspects, NG-RAN 214 configures the UE 202 using, e.g., radio resource control (RRC) protocol signaling over, e.g., LTE-Uu and NR-Uu interfaces. In some aspects, UE 202 uses the LTE-Uu interface to communicate with the ng-eNB 218 and the NR-Uu interface to communicate with the gNB 216. In some aspects, ng-eNB 216 and gNB 216 use NG-C interfaces to communicate with the AMF 244.

In some embodiments, the following reference signals can be used to achieve positioning measurements in NR communication networks: NR positioning reference signal (NR PRS) in the downlink and sounding reference signal (SRS) for positioning in the uplink. The downlink positioning reference signal (PRS) can be used as a reference signal supporting downlink-based positioning techniques. In some aspects, the entire NR bandwidth can be covered by transmitting PRS over multiple symbols that can be aggregated to accumulate power.

FIG. 3 schematically illustrates a wireless network 300 in accordance with various embodiments. The wireless network 300 may include an UE 302 in wireless communication with AN 304. The UE 302 and AN 304 may be similar to, and substantially interchangeable with, like-named components described elsewhere herein.

The UE 302 may be communicatively coupled with the AN 304 via connection 306. Connection 306 is illustrated as an air interface to enable communicative coupling and can be consistent with cellular communications protocols such as an LTE protocol or a 5G NR protocol operating at mmWave or sub-6 GHz frequencies.

The UE 302 may include a host platform 308 coupled with a modem platform 310. The host platform 308 may include application processing circuitry 312, which may be coupled with protocol processing circuitry 314 of the modem platform 310. The application processing circuitry 312 may run various applications for the UE 302 that source/sink application data. The application processing circuitry 312 may further implement one or more layer operations to transmit/receive application data to/from a data network. These layer operations may include transport (for example, UDP) and Internet (for example, IP) operations.

The protocol processing circuitry 314 may implement one or more layer operations to facilitate the transmission or reception of data over connection 306. The layer operations implemented by the protocol processing circuitry 314 may include, for example, MAC, RLC, PDCP, RRC, and NAS operations.

The modem platform 310 may further include digital baseband circuitry 316 that may implement one or more layer operations that are “below” layer operations performed by the protocol processing circuitry 314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 310 may further include transmit circuitry 318, receive circuitry 320, RF circuitry 322, and RF front end (RFFE) 324, which may include or connect to one or more antenna panels 326. Briefly, the transmit circuitry 318 may include a digital-to-analog converter, mixer, intermediate frequency (IF) components, etc.; the receive circuitry 320 may include an analog-to-digital converter, mixer, IF components, etc.; the RF circuitry 322 may include a low-noise amplifier, a power amplifier, power tracking components, etc.; RFFE 324 may include filters (for example, surface/bulk acoustic wave filters), switches, antenna tuners, beamforming components (for example, phase-array antenna components), etc. The selection and arrangement of the components of the transmit circuitry 318, receive circuitry 320, RF circuitry 322, RFFE 324, and one or more antenna panels 326 (referred to generically as “transmit/receive components”) may be specific to details of a specific implementation such as, for example, whether the communication is TDM or FDM, in mmWave or sub-6 GHz frequencies, etc. In some embodiments, the transmit/receive components may be arranged in multiple parallel transmit/receive chains, may be disposed of in the same or different chips/modules, etc.

In some embodiments, the protocol processing circuitry 314 may include one or more instances of control circuitry (not shown) to provide control functions for the transmit/receive components.

A UE reception may be established by and via the one or more antenna panels 326, RFFE 324, RF circuitry 322, receive circuitry 320, digital baseband circuitry 316, and protocol processing circuitry 314. In some embodiments, the one or more antenna panels 326 may receive a transmission from the AN 304 by receive-beamforming signals received by a plurality of antennas/antenna elements of the one or more antenna panels 326.

A UE transmission may be established by and via the protocol processing circuitry 314, digital baseband circuitry 316, transmit circuitry 318, RF circuitry 322, RFFE 324, and one or more antenna panels 326. In some embodiments, the transmit components of the UE 302 may apply a spatial filter to the data to be transmitted to form a transmit beam emitted by the antenna elements of the one or more antenna panels 326.

Similar to the UE 302, the AN 304 may include a host platform 328 coupled with a modem platform 330. The host platform 328 may include application processing circuitry 332 coupled with protocol processing circuitry 334 of the modem platform 330. The modem platform may further include digital baseband circuitry 336, transmit circuitry 338, receive circuitry 340, RF circuitry 342, RFFE circuitry 344, and antenna panels 346. The components of the AN 304 may be similar to and substantially interchangeable with the like-named components of the UE 302. In addition to performing data transmission/reception as described above, the components of the AN 304 may perform various logical functions that include, for example, RNC functions such as radio bearer management, uplink and downlink dynamic radio resource management, and data packet scheduling.

FIG. 4 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 4 shows a diagrammatic representation of hardware resources 400, including one or more processors (or processor cores) 410, one or more memory/storage devices 420, and one or more communication resources 430, each of which may be communicatively coupled via a bus 440 or other interface circuitry. For embodiments where node virtualization (e.g., NFV) is utilized, a hypervisor 402 may be executed to provide an execution environment for one or more network slices/sub-slices to utilize the hardware resources 400.

The one or more processors 410 may include, for example, a processor 412 and a processor 414. The one or more processors 410 may be, for example, a central processing unit (CPU), a reduced instruction set computing 20) (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 420 may include a main memory, disk storage, or any suitable combination thereof. The memory/storage devices 420 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The one or more communication resources 430 may include interconnection or network interface controllers, components, or other suitable devices to communicate with one or more peripheral devices 404 or one or more databases 406 or other network elements via a network 408. For example, the one or more communication resources 430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 450 may comprise software, a program, an application, an applet, an app, or other executable code for causing at least any of the one or more processors 410 to perform any one or more of the methodologies discussed herein. The instructions 450 may reside, completely or partially, within at least one of the one or more processors 410 (e.g., within the processor's cache memory), the memory/storage devices 420, or any suitable combination thereof. Furthermore, any portion of the instructions 450 may be transferred to the hardware resources 400 from any combination of the one or more peripheral devices 404 or the one or more databases 406. Accordingly, the memory of the one or more processors 410, the memory/storage devices 420, the one or more peripheral devices 404, and the one or more databases 406 are examples of computer-readable and machine-readable media.

For one or more embodiments, at least one of the components outlined in one or more of the preceding figures may be configured to perform one or more operations, techniques, processes, and/or methods as outlined in the example sections below. For example, baseband circuitry associated with one or more of the preceding figures may be configured to operate in accordance with one or more of the examples set forth below. For another example, circuitry associated with a UE, base station, satellite, network element, etc., as described above in connection with one or more of the preceding figures may be configured to operate in accordance with one or more of the examples set forth below in the example section.

The term “application” may refer to a complete and deployable package or environment to achieve a specific function in an operational environment. The term “AI/ML application” or the like may be an application that contains some artificial intelligence (AI)/machine learning (ML) models and application-level descriptions. In some embodiments, an AI/ML application may be used for configuring or implementing one or more of the disclosed aspects.

The term “machine learning” or “ML” refers to the use of computer systems implementing algorithms and/or statistical models to perform a specific task(s) without using explicit instructions but instead relying on patterns and inferences. ML algorithms build or estimate mathematical model(s) (referred to as “ML models” or the like) based on sample data (referred to as “training data,” “model training information,” or the like) to make predictions or decisions without being explicitly programmed to perform such tasks. Generally, an ML algorithm is a computer program that learns from experience concerning some task and some performance measure, and an ML model may be any object or data structure created after an ML algorithm is trained with one or more training datasets. After training, an ML model may be used to make predictions on new datasets. Although the term “ML algorithm” refers to concepts different from the term “ML model,” these terms, as discussed herein, may be used interchangeably for the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.), unsupervised learning (e.g., K-means clustering, principal component analysis (PCA), etc.), reinforcement learning (e.g., Q-learning, multi-armed bandit learning, deep RL, etc.), neural networks, and the like. Depending on the implementation, a specific ML model could have many sub-models as components, and the ML model may train all sub-models together. Separately trained ML models can also be chained together in an ML pipeline during inference. An “ML pipeline” is a set of functionalities, functions, or functional entities specific to an ML-assisted solution; an ML pipeline may include one or several data sources in a data pipeline, a model training pipeline, a model evaluation pipeline, and an actor. The “actor” is an entity that hosts an ML-assisted solution using the output of the ML model inference). The term “ML training host” refers to an entity, such as a network function, that hosts the training of the model. The term “ML inference host” refers to an entity, such as a network function, that hosts the model during inference mode (which includes both the model execution as well as any online learning, if applicable). The ML host informs the actor about the output of the ML algorithm, and the actor decides on an action (an “action” is performed by an actor as a result of the output of an ML-assisted solution). The term “model inference information” refers to information used as an input to the ML model for determining inference(s); the data used to train an ML model and the data used to determine inferences may overlap, however, “training data” and “inference data” refer to different concepts.

Mobile communication has evolved significantly from early voice systems to today's highly sophisticated integrated communication platforms. The next-generation wireless communication system, 5G (or NR), will provide access to information and data sharing anywhere and anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, more straightforward, and seamless wireless connectivity solutions. NR will enable everything to be connected wirelessly and deliver fast, rich content and services.

NR supports exact positioning in the vertical and horizontal dimensions, which relies on timing-based, angle-based, power-based, or hybrid techniques to estimate the user location in the network. In particular, the following RAT-dependent positioning techniques were introduced, which can meet the positioning requirements for various use cases, e.g., indoor, outdoor, industrial internet-of-thing (IoT), etc.:
(a) Downlink time difference of arrival (DL-TDOA);
(b) Uplink time difference of arrival (UL-TDOA);
(c) Downlink angle of departure (DL-AoD);
(d) Uplink angle of arrival (UL AoA);
(e) Multi-cell round trip time (multi-RTT); and
(f) NR enhanced cell ID (E-CID).

With wide bandwidth for positioning signals and beamforming capability in the mm-wave frequency band, higher positioning accuracy can be achieved by RAT-dependent positioning techniques. In Rel-16, downlink positioning reference signal (DL PRS) and uplink sounding reference signal (UL SRS) for positioning were introduced as enablers to achieve target performance characteristics.

To further improve the positioning accuracy, bandwidth aggregation for transmission of DL PRS and UL SRS for intra-band contiguous carriers can be considered for single-chain Tx/Rx architectures at both the UE and gNB. In this case, multiple channel observations obtained in different carriers can be processed at the receiver side to form a wideband channel realization, which would result in a sample time duration reduction and the discrete Fourier size extension.

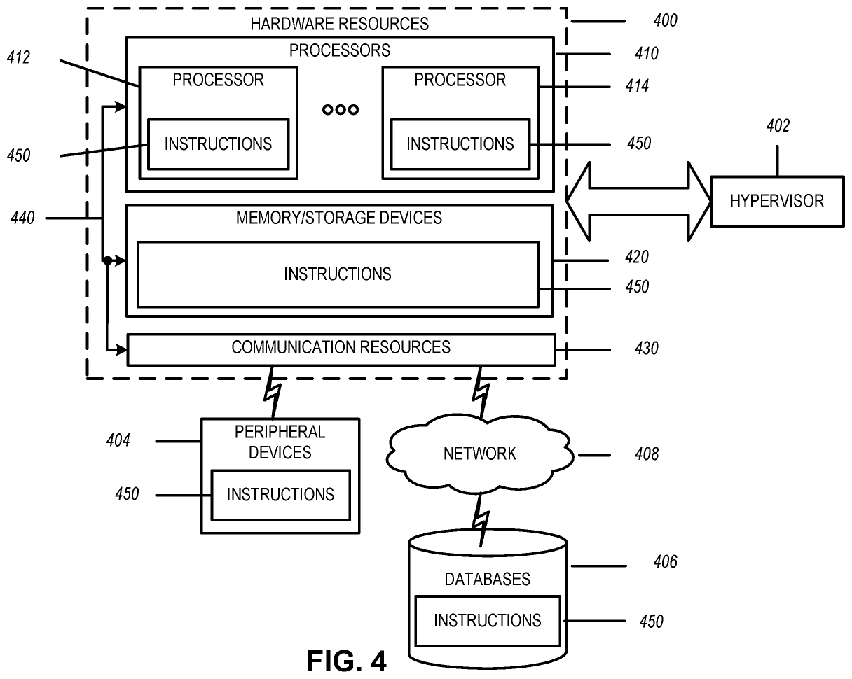

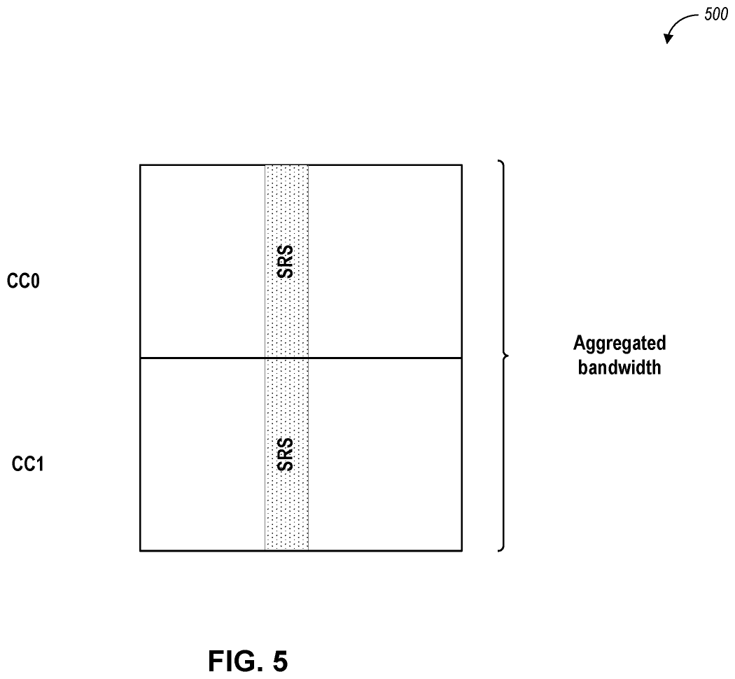

FIG. 5 illustrates diagram 500 of bandwidth aggregation for sounding reference signal (SRS) transmission across intra-band contiguous carriers, in accordance with some aspects. FIG. 5 illustrates one example of bandwidth aggregation for SRS transmission across intra-band contiguous carriers. In the example, SRSs are simultaneously transmitted across two intra-band contiguous carriers to form a wide band for SRS transmission. In this case, a wideband channel is effectively realized based on multiple channel observations to enhance the time resolution of the DL-TDOA, UL-TDOA, and Multi-RTT positioning methods.

In NR, DL PRS and SRS for positioning are transmitted within a carrier. To allow simultaneous transmission of DL PRS and SRS for positioning across intra-band contiguous carriers, specific designs may need to be considered on the configuration and triggering mechanism for bandwidth aggregation.

The disclosed techniques include systems and methods of bandwidth aggregation for positioning enhancement. In particular, the disclosed techniques include bandwidth aggregation for DL PRS and bandwidth aggregation for SRS for positioning.

### Bandwidth Aggregation for DL PRS

As mentioned above, to further improve the positioning accuracy, bandwidth aggregation for transmission of DL PRS and UL SRS for intra-band contiguous carriers can be considered for single-chain Tx/Rx architectures at both the UE and gNB. In this case, multiple channel observations obtained in different carriers can be processed at the receiver side to form a wideband channel realization, which would result in a sample time duration reduction and the discrete Fourier size extension.

In NR, DL PRS and SRS for positioning are transmitted within a carrier. To allow simultaneous transmission of DL PRS and SRS for positioning across intra-band contiguous carriers, specific designs may need to be considered on the configuration and triggering mechanism for bandwidth aggregation.

Embodiments of bandwidth aggregation for DL PRS are provided as follows.

In some embodiments, reception of DL PRS with bandwidth aggregation may be configured to a UE indicating support of the features of DL carrier aggregation (CA) and bandwidth aggregation for DL PRS. In a further example, reception of DL PRS with bandwidth aggregation may be configured on a (sub) set of contiguous intra-band DL component carriers (CCs) that the UE has been configured with for DL CA operation. Alternatively, reception of DL PRS with bandwidth aggregation may be configured on a set of contiguous intra-band DL component carriers (CCs) without being configured for DL CA operation. In this case, the configuration of the DL serving cells other than the primary cell may be provided separately and limited to the reception of DL PRS with bandwidth aggregation. Further, for this case, the reception of DL PRS with bandwidth aggregation may be limited to within measurement gaps in the primary serving cell. As another variant of this case, the CCs for reception of DL PRS with bandwidth aggregation may be provided to a UE independent of the configuration of DL CA, i.e., UE may be configured with DL CA with a different set of carriers than those provided by the Location Management Function (LMF) entity for DL PRS with bandwidth aggregation.

In some embodiments, for reception of DL PRS with bandwidth aggregation in RRC_INACTIVE or RRC_IDLE states, a UE may be provided with PRS configuration including the CCs for reception of DL PRS when the UE is in RRC_CONNECTED state, and reception of DL PRS with bandwidth aggregation may use different subcarrier spacing (SCS) and may be outside the initial DL Bandwidth Part (BWP). Further, in case of time domain conflicts between the reception of DL PRS with bandwidth aggregation and reception of other DL channels/signals in the initial DL BWP in RRC_INACTIVE state, the reception of other DL channels/signals in the initial DL BWP may be prioritized and the UE may not be expected to receive DL PRS with bandwidth aggregation in the affected occasions of DL PRS with bandwidth aggregation. Alternatively, in case of time domain conflicts between the reception of DL PRS with bandwidth aggregation and reception of other DL channels/signals in the initial DL BWP in RRC_INACTIVE state, the reception of other DL channels/signals in the initial DL BWP may be prioritized and the UE may not be expected to receive DL PRS in the affected occasions of DL PRS with bandwidth aggregation in the CC that overlaps with the initial DL BWP in frequency. Further, for the alternative option, the UE may be expected to receive in the other CCs if the SCS and Cyclic Prefix (CP) are the same between the initial DL BWP and the other CCs with DL PRS for bandwidth aggregation.

In case of time domain conflicts between the reception of DL PRS with bandwidth aggregation and transmission of a UL channel/signal in the RRC_INACTIVE state, the reception of DL PRS with bandwidth aggregation may be canceled.

In case of time domain conflicts between the reception of DL PRS with bandwidth aggregation and reception of other DL channels/signals in the RRC_IDLE state, any prioritization between reception of DL PRS with bandwidth aggregation and reception of other DL channels/signals may be left up to UE implementation.

In some aspects, for a UE in RRC_INACTIVE state, a switching time may be provisioned before and after an occasion with DL PRS with bandwidth aggregation during which the UE is not expected to transmit or receive any physical channel/signal. The switching time may be defined in absolute time in the numbers of samples of the basic NR sampling time (Tc) or the numbers of symbols of the smaller of SCS values of the initial DL BWP and initial UL BWP.

In some aspects, for DL PRS, whether bandwidth aggregation across intra-band contiguous carriers is enabled or disabled can be configured as part of NR-DL PRS-PositioningFrequencyLayer, NR-DL PRS-ResourceSet, or NR-DL PRS-Resource or as a separate higher layer parameter.

In addition, for DL PRS with bandwidth aggregation, the UE may expect the same time domain resource configuration and QCL assumption for DL PRS transmission across intra-band contiguous carriers.

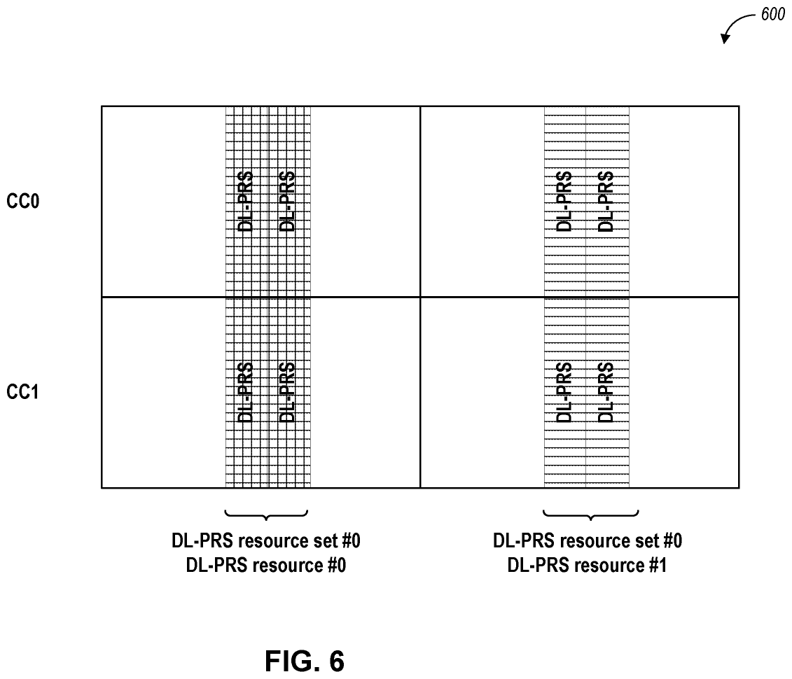

FIG. 6 illustrates diagram 600 of downlink provisioning reference signal (DL PRS) transmission with bandwidth aggregation, in accordance with some aspects. FIG. 6 illustrates one example of DL PRS transmission with bandwidth aggregation. In some aspects, two carriers are used for DL PRS transmission with bandwidth aggregation. Further, one DL PRS resource set includes two DL PRS resources in a cell. For bandwidth aggregation, the same time domain resource configuration is configured for two DL PRS resource sets in two intra-band contiguous carriers.

In some embodiments, for DL PRS with bandwidth aggregation, UE may expect phase continuity and power consistency for DL PRS transmissions across intra-band contiguous carriers.

In some aspects, for DL PRS with bandwidth aggregation, the UE may expect the same configuration of measurement gap and/or PRS Processing Window across intra-band contiguous carriers.

As a further extension, more than one measurement gap may be activated or deactivated across intra-band contiguous carriers via Medium Access Control-Control Element (MAC-CE) simultaneously, where each measurement gap may be activated or deactivated in a carrier. In particular, a new Extended logical channel ID (eLCID) may be defined for activation/deactivation of measurement gap across intra-band contiguous carriers.

In some aspects, an association between the DL PRS frequency layer in a first carrier and the DL PRS frequency layer in a second carrier can be defined and configured by higher layers via RRC signaling for DL PRS with bandwidth aggregation. In this case, when the DL PRS frequency layer in the first carrier is configured for DL PRS with bandwidth aggregation, the DL PRS frequency layer in the second carrier is also configured in accordance with the association.

In some embodiments, an association between the DL PRS resource set in a first PRS frequency layer and the DL PRS resource set in a second PRS frequency layer can be defined and configured by higher layers via RRC signaling for DL PRS with bandwidth aggregation. In this case, when the DL PRS resource set in the first carrier is configured for DL PRS with bandwidth aggregation, the DL PRS resource set in the second carrier is also configured in accordance with the association.

In some aspects, an association between a DL PRS resource in a first carrier and a DL PRS resource in a second carrier can be defined and configured by higher layers via RRC signaling for DL PRS with bandwidth aggregation. In this case, when the DL PRS resource in the first carrier is configured for DL PRS with bandwidth aggregation, the DL PRS resource in the second carrier is also configured in accordance with the association.

In some embodiments, for DL PRS bandwidth aggregation, the UE may assume that a DL PRS resource in the same symbol(s) in different carriers has the same QCL assumption with a reference signal from a reference carrier.

In some aspects, for DL PRS bandwidth aggregation, if DL PRS resources in the same symbol(s) in different carriers/cells are each QCL′ed (quasi-colocated) with a reference signal for the respective carrier/cell, the UE may assume that the reference signals from different carriers/cells have same QCL assumption.

In some aspects, the reference carrier may be determined in accordance with at least one or a combination of the following options:
(a) the reference carrier may be the cell with the lowest or largest serving cell for DL PRS bandwidth aggregation;
(b) the reference carrier may be configured by higher layers via RRC signaling;
(c) the reference carrier may be the cell that is configured for DL PRS positioning for bandwidth aggregation. In this case, the positioning frequency layer, the DL PRS resource set, and/or the DL PRS resource in other carriers for bandwidth aggregation may be associated with the positioning frequency layer, the DL PRS resource set, and/or DL PRS resource in the reference carrier.

(d) the reference carrier may be the primary cell.

### Bandwidth Aggregation for SRS for Positioning

Embodiments of bandwidth aggregation for SRS (also referred to as UL SRS) for positioning are provided as follows.

In one embodiment, the transmission of SRS for positioning with bandwidth aggregation may be configured to a UE, indicating support of the features of UL CA and bandwidth aggregation for SRS for positioning. In a further example, the transmission of SRS for positioning with bandwidth aggregation may be configured on a (sub) set of contiguous intra-band UL component carriers (CCs) that the UE has been configured with for UL CA operation. In this case, a gNB (as an example of an NG-RAN node) may provide information on the configuration of the UL CCs and SRS configurations to an LMF using NR Positioning Protocol A (NRPPa).

Alternatively, the transmission of SRS for positioning with bandwidth aggregation may be configured on a set of contiguous intra-band UL component carriers (CCs) without configuration for UL CA operation. In this case, the configuration of the UL serving cells other than the primary cell may be provided separately and limited only to the transmission of SRS for positioning with bandwidth aggregation. More generally, the CCs for the transmission of SRS for positioning (SRSp) with bandwidth aggregation may be provided to a UE independent of the configuration of UL CA, i.e., the UE may be configured with UL CA with a different set of carriers than those provided for transmission of SRSp with bandwidth aggregation.

In either of the cases with decoupled configurations between UL CA and SRSp with bandwidth aggregation, a switching time may be provisioned before and after an occasion with SRSp with bandwidth aggregation during which the UE is not expected to transmit or receive any physical channel/signal. The switching time may be defined in absolute time in numbers of samples of the basic NR sampling time (Tc) or numbers of symbols of the smaller of the SCS values of the active DL BWP or active UL BWP or in numbers of symbols of the SCS value of the active UL BWP.

In some embodiments, for transmission of SRSp with bandwidth aggregation in the RRC_INACTIVE state, a UE may be provided with SRSp configuration including the CCs for transmission of SRSp when the UE is in RRC_CONNECTED state or via broadcasting of System Information Block (SIB) signaling, and transmission of SRSp with bandwidth aggregation may use different subcarrier spacing (SCS) and may be outside the initial UL BWP.

In some aspects, in case of time domain conflicts between transmission of SRSp with bandwidth aggregation and transmission of a UL channel/signal in initial UL BWP in RRC_INACTIVE state, the transmission of SRSp with bandwidth aggregation may be canceled in all CCs provided for transmission of SRSp with bandwidth aggregation. Alternatively, in case of time domain conflicts between reception of SRSp with bandwidth aggregation and transmission of an UL channel/signal in the initial UL BWP in RRC_INACTIVE state, the transmission of the UL channel/signal in the initial UL BWP may be prioritized, and the UE may not be expected to transmit SRSp in the affected occasions of SRSp with bandwidth aggregation in the CC that overlaps with the initial UL BWP in frequency. Further, for the alternative option, the UE may be expected to transmit in the other CCs if the SCS and Cyclic Prefix (CP) are the same between the initial UL BWP and the other CCs with SRSp for bandwidth aggregation. However, depending on deployment and use-case, the alternative option not be possible if the LMF and neighboring cells that may be receiving the SRSp with bandwidth aggregation may not be aware of the cancellation of SRSp transmission in the CC overlapping with initial UL BWP of the UE.

In some aspects, for a UE in RRC_INACTIVE state, a switching time may be provisioned before and after an occasion with SRSp with bandwidth aggregation during which the UE is not expected to transmit or receive any physical channel/signal. The switching time may be defined in absolute time in the numbers of samples of the basic NR sampling time (Tc) or the numbers of symbols of the smaller of SCS values of the initial DL BWP or initial UL BWP.

In some aspects, for SRS for positioning, whether bandwidth aggregation across intra-band contiguous carriers is enabled or disabled can be configured as part of SRS-PosResourceSet configuration or as a separate higher-layer parameter. For semi-persistent SRS transmission for positioning, when bandwidth aggregation is configured for an activated SRS resource set, SRS is transmitted across intra-band contiguous carriers. Similarly, for aperiodic SRS transmission for positioning, when bandwidth aggregation is configured for triggered SRS resource set, SRS is transmitted across intra-band contiguous carriers.

In another embodiment, for SRS for positioning with bandwidth aggregation, an SRS resource set for positioning may be configured with a set of carrier and bandwidth part (BWP) indexes. Further, for periodic SRS transmission for positioning, the same SRS resource configuration in time in the configured cell and BWP may be repeated across the configured set of carriers and BWPs in the configured SRS resource set. For semi-persistent SRS transmission for positioning, the same SRS resource configuration in time in the activated cell and BWP may be repeated across the configured set of carriers and BWPs in the activated SRS resource set. For aperiodic SRS transmission for positioning, the same SRS resource configuration in time in the triggered cell and BWP may be repeated across the configured set of carriers and BWPs in the triggered SRS resource set.

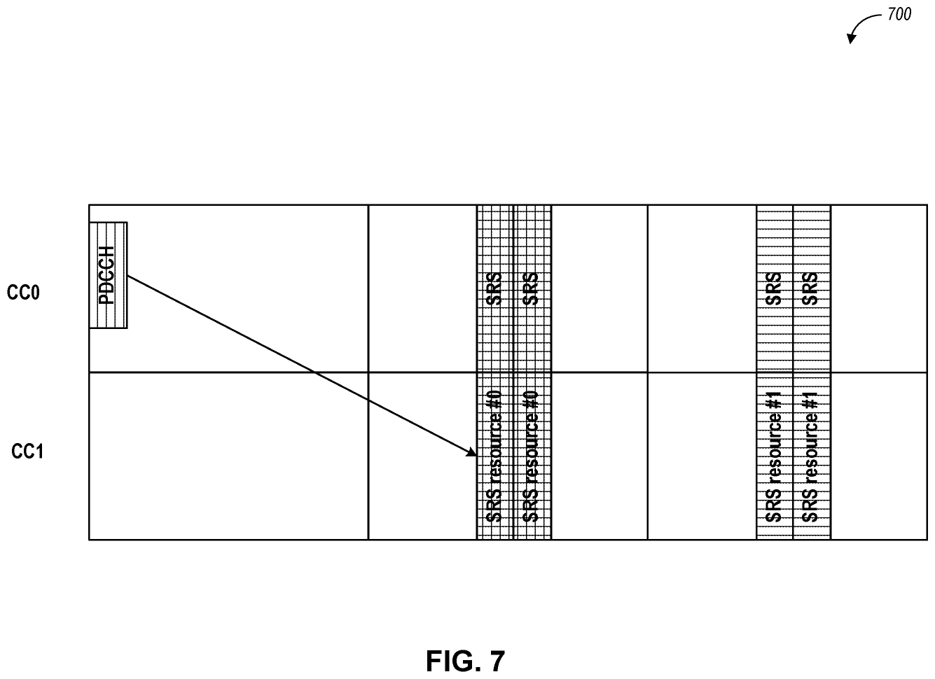

FIG. 7 illustrates diagram 700 of the same SRS resource configuration across intra-band contiguous carriers, in accordance with some aspects. FIG. 7 illustrates the same SRS resource configuration across intra-band contiguous carriers for positioning. In the example, two carriers are used for SRS transmission for positioning with bandwidth aggregation. In addition, an SRS resource set with two SRS resources in CC1 is triggered by a physical downlink control channel (PDCCH). Based on the aforementioned option, the same SRS resource configuration from CC1 is repeated in CC0 for SRS transmission for positioning.

In another option, a long SRS sequence may be generated based on the allocated bandwidth across all the configured, activated, or triggered serving cells for SRS transmission for positioning with bandwidth aggregation. The starting RE for SRS transmission may be determined in accordance with the configuration in a first serving cell for SRS transmission.

In another embodiment of the invention, for SRS for positioning with bandwidth aggregation, an SRS resource set for positioning may be configured with a set of carrier and BWP indexes. Further, for periodic SRS transmission for positioning, SRS is transmitted based on the same SRS resource set ID across the configured set of carriers and BWPs in the configured SRS resource set. In this case, UE determines the SRS resource set ID based on the configuration and uses the same SRS resource set ID from the configured set of carriers and BWPs for SRS transmission.

For semi-persistent SRS transmission for positioning, SRS is transmitted based on the same SRS resource set ID across the configured set of carriers and BWPs in the activated SRS resource set. In this case, UE determines the SRS resource set ID based on the activation and uses the same SRS resource set ID from the configured set of carriers and BWPs in the activated SRS resource set for SRS transmission.

For aperiodic SRS transmission for positioning, SRS is transmitted based on the same SRS resource set ID across the configured set of carriers and BWPs in the triggered SRS resource set. In this case, the UE determines the SRS resource set ID based on the SRS request field in the DCI and uses the same SRS resource set ID from the configured set of carriers and BWPs in the triggered SRS resource set for SRS transmission.

In some aspects, UE may expect same-time domain resource allocation, including symbol and slot index for SRS transmission across intra-band contiguous carriers. Further, UE may expect the same spatial relations in the same symbols for SRS transmission across intra-band contiguous carriers.

In another embodiment, an association between the SRS resource set for positioning in a first carrier and the SRS resource set for positioning in a second carrier can be defined and configured by higher layers via RRC signaling for SRS with bandwidth aggregation. For periodic SRS transmission for positioning, when the SRS resource set for positioning in the first carrier is configured for SRS transmission with bandwidth aggregation, the SRS resource set for positioning in the second carrier is also used for SRS for positioning in accordance with the association.

For semi-persistent SRS transmission for positioning, when the SRS resource set for positioning in the first carrier is activated or deactivated for SRS transmission with bandwidth aggregation, the SRS resource set for positioning in the second carrier is also activated or deactivated for SRS for positioning in accordance with the association.

For aperiodic SRS transmission for positioning, when the SRS resource set for positioning in the first carrier is triggered for SRS transmission with bandwidth aggregation, the SRS resource set for positioning in the second carrier is also triggered for SRS for positioning in accordance with the association.

In another embodiment, an association between the SRS resource for positioning in a first carrier and the SRS resource for positioning in a second carrier can be defined and configured by higher layers via RRC signaling for SRS with bandwidth aggregation.

For periodic SRS transmission for positioning, when the SRS resource set for positioning, including the SRS resource in the first carrier, is configured for SRS transmission with bandwidth aggregation, the SRS resource for positioning in the second carrier is also used for SRS for positioning in accordance with the association.

For semi-persistent SRS transmission for positioning, when the SRS resource set for positioning, including the SRS resource in the first carrier, is activated or deactivated for SRS transmission with bandwidth aggregation, the SRS resource for positioning in the second carrier is also activated or deactivated for SRS for positioning in accordance with the association.

For aperiodic SRS transmission for positioning, when the SRS resource set for positioning, including the SRS resource in the first carrier, is triggered for SRS transmission with bandwidth aggregation, the SRS resource for positioning in the second carrier is also triggered for SRS for positioning in accordance with the association.

In another embodiment, for SRS for positioning with bandwidth aggregation, an SRS resource set may be configured with more than one SRS resource, where each SRS resource is associated with a carrier and BWP in the carrier. Further, in case the carrier and BWP index are not configured within an SRS resource. For periodic SRS transmission for positioning, configured cell and BWP index associated with the configured SRS resource set is applied for the SRS resource. For semi-persistent SRS transmission for positioning, activated cell and BWP index associated with the activated SRS resource set are applied for the SRS resource. For aperiodic SRS transmission for positioning, the triggered cell and BWP index associated with the triggered SRS resource set are applied for the SRS resource.

In some aspects, the UE may expect the same time domain resource allocation, including symbol and slot index for SRS transmission across intra-band contiguous carriers. Further, the UE may expect the same spatial relations in the same symbols for SRS transmission across intra-band contiguous carriers.

In another embodiment of the invention, for SRS for positioning with bandwidth aggregation, an SRS resource set may include more than one SRS resource group, where each SRS resource group is associated with a carrier and a BWP in the carrier. In addition, each SRS resource group may include more than one SRS resource.

In some aspects, when the carrier and BWP index are not configured for an SRS resource group within an SRS resource set, for periodic SRS transmission for positioning, configured cell and BWP index associated with the configured SRS resource set is applied for the SRS resource group. For semi-persistent SRS transmission for positioning, activated cell and BWP index associated with the activated SRS resource set are applied for the SRS resource group. For aperiodic SRS transmission for positioning, the triggered cell and BWP index associated with the triggered SRS resource set are applied for the SRS resource group.

In another embodiment, for semi-persistent SRS for positioning with bandwidth aggregation, more than one SRS resource set across intra-band contiguous carriers may be activated or deactivated via Medium Access Control-Control Element (MAC-CE). In addition, a new Extended logical channel ID (eLCID) may be defined for semi-persistent SRS for positioning with bandwidth aggregation.

In one option, a set of carriers and associated BWPs may be included in the activation/deactivation MAC-CE. Further, activated or deactivated SRS resource set in each carrier and associated BWP may be included in the MAC-CE.

In another option, a starting carrier, a number of carriers, and associated BWP in each carrier may be included in the activation/deactivation MAC-CE. Further, activated or deactivated SRS resource set in each determined carrier and associated BWP may be included in the MAC-CE.

In some aspects, the UE may expect the same time domain resource allocation, including symbol and slot index for SRS transmission across intra-band contiguous carriers. Further, the UE may expect the same spatial relations in the same symbols for SRS transmission across intra-band contiguous carriers.

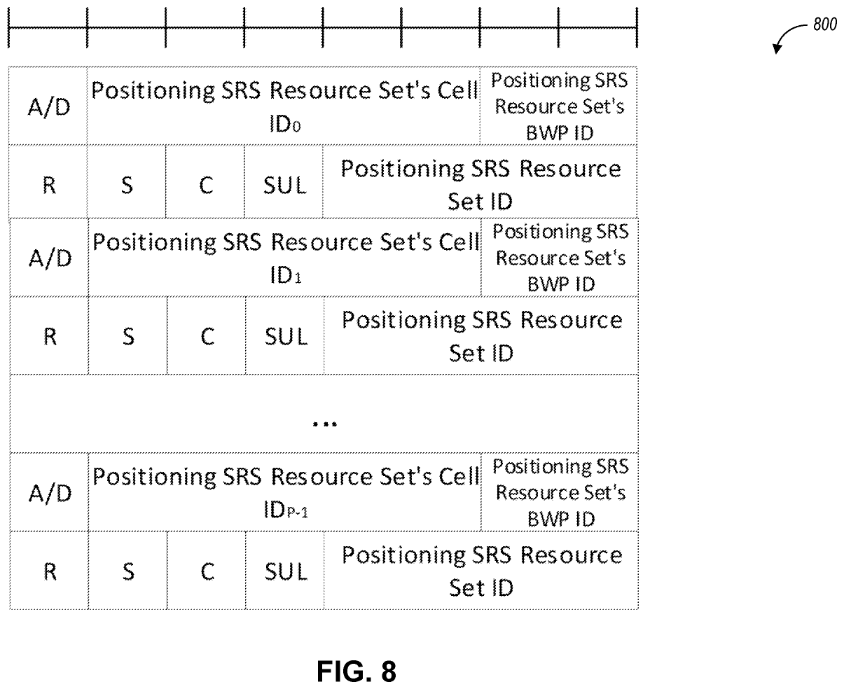

FIG. 8 illustrates diagram 800 of MAC-CE with activation and deactivation of semi-persistent SRS for positioning with bandwidth aggregation, in accordance with some aspects. FIG. 8 illustrates one example of MAC-CE with activation and deactivation of semi-persistent SRS for positioning with bandwidth aggregation. In the example, SRS resource sets in P serving cells can be activated for positioning with bandwidth aggregation. In some aspects, spatial relations for different SRS resources may also be included in the MAC-CE.

In another embodiment, for aperiodic SRS transmission for positioning with bandwidth aggregation, a joint SRS request field can be included in the DCI for triggering SRS transmissions in multiple CCs simultaneously. In particular, the joint SRS request field is used to indicate the SRS request information to each co-scheduled carrier. Further, the joint SRS request field may indicate a row of a table for an SRS request, which is configured by RRC signaling.

In some aspects, the DCI format may include DCI format 0_1, 0_2, 1_1, 1_2, and DCI format for multi-cell scheduling.

In one option, more than one set of serving cells and/or associated BWPs in the serving cell may be configured by higher layers via RRC signaling. A code point of the SRS request field in the DCI may be used to indicate one of more than one set of serving cells and/or associated BWPs are used for SRS transmission for positioning. Further, the SRS resource set for positioning may be triggered when bandwidth aggregation in the configuration of the SRS resource set for positioning is enabled. The set of serving cells may be configured with intra-band contiguous carriers for positioning with bandwidth aggregation.

In some aspects, if BWP is not configured by higher layers, the same BWP ID as the current active BWP or triggered BWP ID in the scheduled cell in the DCI may be used to determine the SRS resource set for positioning. Alternatively, if BWP is not configured by higher layers, the same BWP ID as the current active BWP for the scheduling cell and the BWP with the lowest index for serving cells other than the scheduling cell may be used to determine the SRS resource sets, respectively.

Table 1 illustrates one example of an aperiodic SRS resource set(s) for positioning with bandwidth aggregation. More specifically, Table 1 illustrates triggering aperiodic SRS resource set(s) for positioning with bandwidth aggregation: Option 1. In the example, code point “01”, “10” and “11” in the SRS request field is used to indicate SRS resource set(s) configured with higher layer parameter SRS-PosResourceSet and “bandwidth aggregation” set to enabled, and resourceType in SRS-PosResourceSet set to ‘aperiodic’ for a 1st, 2nd and 3rd set of serving cells and/or associated BWPs configured by higher layers, respectively. In some aspects, a set of serving cells may be intra-band contiguous carriers.

TABLE 1

| SRS | |
|---|---|
| re- | |
| quest | Triggered aperiodic SRS resource set(s) for positioning with |
| field | bandwidth aggregation |
| 0 | No aperiodic SRS resource set for positioning is triggered |
| 1 | SRS resource set(s) configured with higher layer parameter SRS- |
| | PosResourceSet and “bandwidth aggregation” set to enabled, and |
| | resourceType in SRS-PosResourceSet set to ‘aperiodic’ for a 1^{st} |
| | set of serving cells or a 1^{st} set of serving cells and associated |
| | BWPs configured by higher layers |
| 2 | SRS resource set(s) configured with higher layer parameter SRS- |
| | PosResourceSet and “bandwidth aggregation” set to enabled, and |
| | resourceType in SRS-PosResourceSet set to ‘aperiodic’ for a 2^{nd} |
| | set of serving cells or a 2^{nd} set of serving cells and associated |
| | BWPs configured by higher layers |
| 3 | SRS resource set(s) configured with higher layer parameter SRS- |
| | PosResourceSet and “bandwidth aggregation” set to enabled, and |
| | resourceType in SRS-PosResourceSet set to ‘aperiodic’ for a 3^{rd} |
| | set of serving cells or a 3^{rd} set of serving cells and associated |
| | BWPs configured by higher layers |

In another option, for aperiodic SRS for positioning with bandwidth aggregation, a first serving cell is determined in accordance with the indicated cell index from the DCI. Further, a code point in the SRS request field may be used to indicate a number of contiguous carriers. In one example, cell #1 is indicated in the DCI for SRS transmission, and 2 cells are indicated in the SRS request field. In this case, cell #1 and cell #2 are used for SRS transmission for positioning for bandwidth aggregation.

Table 2 illustrates one example of an aperiodic SRS resource set(s) for positioning with bandwidth aggregation. More specifically, Table 2 illustrates Triggering aperiodic SRS resource set(s) for positioning with bandwidth aggregation: Option 2. In the example, code point “01”, “10,” and “11” in SRS request field is used to indicate SRS resource set(s) configured with higher layer parameter SRS-PosResourceSet and “bandwidth aggregation” set to enabled, and resourceType in SRS-PosResourceSet set to ‘aperiodic’ for a 1st, 2nd and 3rd number of serving cells and/or associated BWPs, respectively.

TABLE 2

| SRS | |
|---|---|
| re- | |
| quest | Triggered aperiodic SRS resource set(s) for positioning with |
| field | bandwidth aggregation |
| 0 | No aperiodic SRS resource set for positioning is triggered |
| 1 | SRS resource set(s) configured with higher layer parameter SRS- |
| | PosResourceSet and “bandwidth aggregation” set to enabled, and |
| | resourceType in SRS-PosResourceSet set to ‘aperiodic’ for a 1^{st} |
| | number of serving cells or a 1^{st} number of serving cells and |
| | associated BWPs |
| 2 | SRS resource set(s) configured with higher layer parameter SRS- |
| | PosResourceSet and “bandwidth aggregation” set to enabled, and |
| | resourceType in SRS-PosResourceSet set to ‘aperiodic’ for a a 2^{nd} |
| | number of serving cells or 2^{nd} number of serving cells and |
| | associated BWPs |
| 3 | SRS resource set(s) configured with higher layer parameter SRS- |
| | PosResourceSet and “bandwidth aggregation” set to enabled, and |
| | resourceType in SRS-PosResourceSet set to ‘aperiodic’ for a 3^{rd} |
| | number of serving cells or a 3^{rd} number of serving cells and |
| | associated BWPs |

As a further extension, to differentiate the SRS request for positioning with bandwidth aggregation and the SRS request for other purposes, one bit field may be included in the DCI format 0_1, 0_2, 1_1, 1_2, and/or the DCI format for multi-cell scheduling. In one example, bit “1” may be used to indicate that the SRS request is used for SRS for positioning with bandwidth aggregation, while bit “0” may be used to indicate that the SRS request is not used for SRS for positioning with bandwidth aggregation.

In another option, to differentiate the SRS request for positioning with bandwidth aggregation and the SRS request for other purposes, some unused state or fields may be repurposed to indicate the SRS request for positioning with bandwidth aggregation.

In another option, to differentiate the SRS request for positioning with bandwidth aggregation and the SRS request for other purposes, a separate search space set may be configured for monitoring the DCI format, which includes the SRS request for positioning with bandwidth aggregation.

In another option, to differentiate the SRS request for positioning with bandwidth aggregation and the SRS request for other purposes, a separate search space set may be configured for monitoring the DCI format, which includes the SRS request for positioning with bandwidth aggregation.

In another embodiment, a group common DCI may be defined to trigger SRS transmission for positioning with bandwidth aggregation.

In one option, the existing DCI format 2_3 may be extended to support the triggering of SRS transmission for positioning with bandwidth aggregation. In this case, a new configuration field may be configured, e.g., Type C, to indicate that the DCI format 2_3 is used to trigger SRS transmission for positioning with bandwidth aggregation. Further, the aforementioned embodiments for triggering SRS transmission using SRS request via UE specific DCI format can be applied for group common DCI.

In another option, a new group common DCI format may be defined to support the triggering of SRS transmission for positioning with bandwidth aggregation. In this case, a new Radio Network Temporary Identifier (RNTI) may be configured to UE to monitor the new group common DCI format. Further, the aforementioned embodiments for triggering SRS transmission using SRS request via UE specific DCI format can be applied for group common DCI.

In an embodiment of the invention, cross-carrier scheduling or triggering of SRS for positioning using single or multiple DCI formats or single or multiple MAC CEs in a scheduling cell may be configured to a UE that indicates support of cross-carrier scheduling for carrier aggregation, i.e., via RANI feature group (FG) #6-10. Alternatively, cross-carrier scheduling or triggering of SRS for positioning using single or multiple DCI formats or single or multiple MAC CEs in a scheduling cell may be configured to a UE that indicates support of cross-carrier indication for transmission of SRS for positioning with bandwidth aggregation that is reported separately from FG #6-10.

In another embodiment, when configured by higher layers for transmission of SRS for positioning with bandwidth aggregation, the UE may receive the activation and/or deactivation command of SRS resource sets across intra-band contiguous carriers using separate MAC-CE. Further, the UE may expect the same starting time for the transmission of SRS for positioning with bandwidth aggregation for semi-persistent SRS transmissions. In addition, UE may expect the same time domain resource allocation, including symbol and slot index for SRS transmission across intra-band contiguous carriers.

In another embodiment, when configured by higher layers for transmission of SRS for positioning with bandwidth aggregation, the UE may receive the activation and/or deactivation command of SRS resource sets across intra-band contiguous carriers from different PDCCHs. Further, the UE May expect the same starting time for the transmission of SRS for positioning with bandwidth aggregation for semi-persistence SRS transmissions. In addition, the UE may expect the same time domain resource allocation, including symbol and slot index for triggered SRS transmission across intra-band contiguous carriers. Further, the UE may expect the same spatial relations in the same symbols for SRS transmission across intra-band contiguous carriers.

In one option, if the UE misses at least one DCI for triggering SRS transmission for positioning with bandwidth aggregation, the UE may not transmit the SRS for positioning across intra-band contiguous carriers.

In another option, if the UE misses at least one DCI for triggering SRS transmission for positioning with bandwidth aggregation, the UE may still transmit the SRS for positioning across intra-band contiguous carriers. In some aspects, the UE may assume the same time domain resource configuration for SRS transmission for positioning across intra-band contiguous carriers.

In another embodiment, for SRS for positioning with bandwidth aggregation, the UE may receive the activation and/or deactivation command of SRS resource sets across intra-band contiguous carriers from different PDCCHs (e.g., per CC). Further, the UE may expect the same or different starting time for the transmission of SRS for positioning with bandwidth aggregation for semi-persistence SRS transmissions. In addition, the UE can assume the same triggering DCI content for SRS across CCs in intra-band CA when the UE is configured with bandwidth aggregation.

In some aspects, for SRS for positioning with bandwidth aggregation, UE may transmit SRS in different carriers using the same power spectral density (PSD) on allocated subcarriers.

In one option, UE determines the transmit power for SRS transmission in a reference BWP and/or carrier based on the pathloss measurement and a set of power control parameters in the reference BWP and/or cell. Further, UE applies the determined PSD from the reference BWP and/or carrier for the SRS transmission in other carriers for SRS for positioning with bandwidth aggregation.

In another option, UE measures the DL pathloss for SRS transmission in a reference BWP and/or carrier and applies the measured pathloss from the reference BWP and/or carrier to determine transmit power for SRS transmission in other BWP and/or carriers for SRS with bandwidth aggregation. In this case, UE may assume the same set of parameters for SRS transmit power in different cells.

In another option, the same values for the power control parameter including P_{O_SRS,b,f,c}(qₛ) and α_{SRS,b,f,c}(qₛ) may be configured for the transmit power of SRS transmission in active BWP in different carriers for SRS for positioning with bandwidth aggregation where qₛ corresponds to the set of SRS resource sets or SRS resources that are aggregated across the different carriers. In addition, the same reference signal for pathloss calculation for each carrier can be configured for SRS transmission across contiguous carriers. In one example, a reference signal for pathloss calculation in a reference cell can be configured for SRS transmission in different carriers.

In some aspects, the reference BWP and/or carrier may be determined in accordance with at least one or a combination of the following options:
(a) the reference BWP and/or carrier may be the cell with the lowest or largest serving cell for SRS with bandwidth aggregation;
(b) the reference BWP and/or carrier may be configured by higher layers via RRC signaling;
(c) the reference BWP and/or carrier may be the BWP and/or carrier that is configured, activated, or triggered for SRS for positioning for bandwidth aggregation. In this case, the SRS resource set and/or SRS resource in other carriers for bandwidth aggregation may be associated with the SRS resource set and/or SRS resources in the reference carrier.
(d) the reference carrier may be the primary cell;
(e) the reference carrier may have SSB transmission; and
(f) the reference carrier may be configured with p0-r16 and alpha-r16.

In another embodiment, for SRS for positioning with bandwidth aggregation, UE may assume that an SRS resource in the same symbol(s) in different carriers has the same spatial relation with other reference signals from a reference carrier.

In some aspects, for SRS for positioning with bandwidth aggregation, if a UE is configured with an SRS resource in the same symbol(s) in different carriers, each with spatial relation to a reference signal for the respective carrier, the UE may assume that the reference signals from different cells have same QCL assumption.

In some aspects, the reference BWP and/or carrier may be determined in accordance with at least one or a combination of the following options:
(a) the reference BWP and/or carrier may be the cell with the lowest or largest serving cell for SRS with bandwidth aggregation;
(b) the reference BWP and/or carrier may be configured by higher layers via RRC signaling;
(c) the reference BWP and/or carrier may be the BWP and/or carrier that is configured, activated, or triggered for SRS for positioning for bandwidth aggregation. In this case, the SRS resource set and/or SRS resource in other carriers for bandwidth aggregation may be associated with the SRS resource set and/or SRS resources in the reference carrier.

(d) the reference carrier may be the primary cell.

In one embodiment, when the total transmit power for SRS transmission and other physical uplink channels/signals (if any) exceeds the maximum transmit power that is configured for a UE, UE may cancel the SRS transmission in one or more carriers until the total transmit power does not exceed the maximum transmit power. In other words, SRS transmission in the one or more carriers has a lower priority compared to other SRS transmission and/or other physical uplink channels/signals, if any.

In one option, the one or more carriers may be determined based on the carrier index for SRS for positioning with bandwidth aggregation. In one example, SRS transmission the one or more carriers with ascending order or descending order of carrier index may be canceled until the total transmit power does not exceed the maximum transmit power.

In one example, assuming SRS for positioning with bandwidth aggregation is transmitted in carriers #0, #1, and #2 in the same symbol(s), and if the total transmit power exceeds the maximum transmit power, SRS for positioning in carrier #1 and #2 may be canceled so that the total transmit power does not exceed the maximum transmit power.

In another embodiment, when the total transmit power for SRS transmission and other physical uplink channels/signals (if any) exceeds the maximum transmit power that is configured for a UE, UE may cancel the SRS transmissions in all the carriers configured for SRS bandwidth aggregation if SRS transmission in any of the carriers may be canceled in order to ensure that the total transmit power does not exceed the maximum transmit power. In a further example, if one or more SRS transmission(s) in a carrier that is not configured for SRS bandwidth aggregation is canceled, the UE may not cancel the SRS transmissions in carriers configured with SRS bandwidth aggregation.

In another embodiment of the invention, when the total transmit power for SRS transmission across intra-band contiguous carriers exceeds the maximum transmit power that is configured for an UE, a scaling factor may be applied for the transmit power of SRS transmission in each carrier so that the total transmit power does not exceed the maximum transmit power.

In one example, when only simultaneous SRS across intra-band contiguous carriers are transmitted in a symbol in a slot, the

$$10 {log}_{10} ( α ) + {\sum }_{c = 0}^{{N}_{SRS}} {P}_{SRS , b , f , c} ( i , {q}_{s} ) \leq {P}_{CMAX , f , c} ( i ) , where {P}_{SRS , b , f , c} ( i , {q}_{s} )$$

is SRS transmission power in SRS transmission occasion i on active UL BWP b of carrier f of serving cell c; P_{CMAX,f,c}(i) is the UE configured maximum output power defined in [8, TS 38.101-1], [8-2, TS 38.101-2] and [TS 38.101-3] for carrier f of serving cell c in SRS transmission occasion i; and a is the scaling factor.

In another option, one or more scaling factors may be configured for SRS for positioning with bandwidth aggregation. The UE may determine a scaling factor from the one or more scaling factors for SRS transmit power, such that the scaling factor is the largest value from the configured values that satisfies

$$10 {log}_{10} ( α ) + {\sum }_{c = 0}^{{N}_{SRS}} {P}_{SRS , b , f , c} ( i , {q}_{s} ) \leq {P}_{CMAX , f , c} ( i ) .$$

As a further extension, if the determined scaling factor is less than the smallest value that is configured for the SRS transmission for positioning with bandwidth aggregation, UE may cancel the SRS transmission in one or more carriers based on aforementioned rule. In some aspects, these techniques may also apply for the case when simultaneous SRS transmission with bandwidth aggregation and other physical uplink channels/signals in the same symbol(s). The other uplink channels/signals may include, but may not be limited to PUSCH, PUCCH, PRACH, DMRS, and PT-RS.

In another embodiment, the same resource type is needed to enable SRS for positioning with bandwidth aggregation. In particular, when periodic SRS transmission is configured in a first carrier, only periodic SRS transmission is configured in a second carrier in the same symbol(s) for SRS for positioning with bandwidth aggregation. When semi-persistent SRS transmission is activated or released in a first carrier, only semi-persistent SRS transmission is activated or released in a second carrier in the same symbol(s) for SRS for positioning with bandwidth aggregation, respectively. When aperiodic SRS transmission is triggered in a first carrier, only aperiodic SRS transmission is triggered in a second carrier in the same symbol(s) for SRS for positioning with bandwidth aggregation.

In another option, different resource types can be used to enable SRS for positioning with bandwidth aggregation. As a further extension, periodic and semi-persistent SRS transmission may be configurated or activated in the same symbol(s) for SRS for positioning with bandwidth aggregation. In particular, when periodic SRS transmission is configured in a first carrier, periodic or semi-persistent SRS transmission can be configured or activated in a second carrier in the same symbol(s) for SRS for positioning with bandwidth aggregation.

In one embodiment, the UE may need to maintain phase continuity and/or power consistency for simultaneous transmission of SRSs for positioning across intra-band contiguous carriers.

Events which cause phase continuity and/or power consistency not to be maintained across SRS transmissions for positioning in intra-band contiguous carriers can be defined as a dropping or cancellation of an SRS transmission in a carrier in accordance with Clause 11.1 in 3GPP TS 38.213 and Clause 6.2.1 in TS38.214.

In some aspects, when SRS transmission in more than one intra-band contiguous carriers is not dropped or canceled, UE may still need to maintain phase continuity and/or power consistency for simultaneous transmission of the SRS.

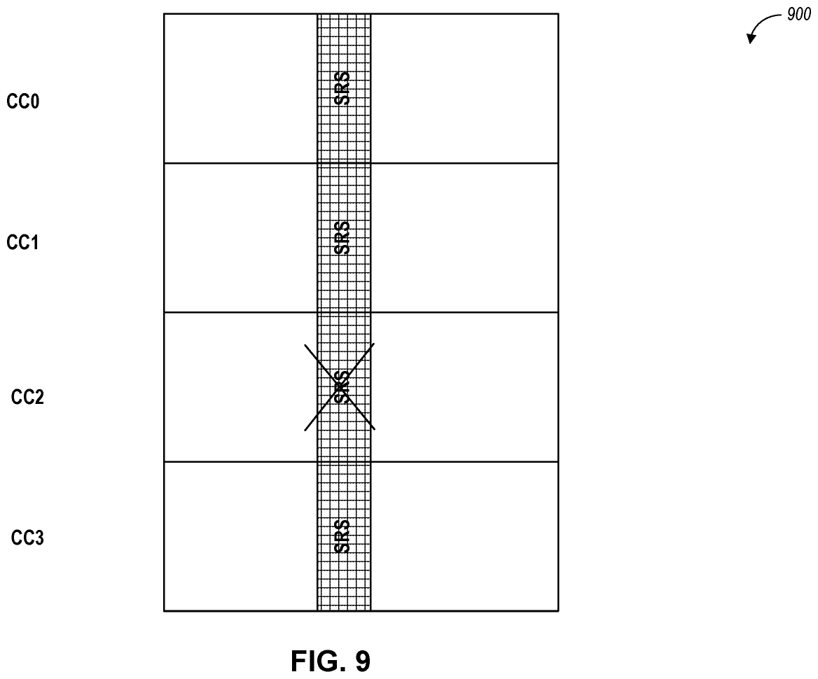

FIG. 9 illustrates diagram 900 of phase continuity and/or power consistency for simultaneous transmission of SRSs, in accordance with some aspects. More specifically, FIG. 9 illustrates one example of phase continuity and/or power consistency for simultaneous transmission of SRSs. In the example, SRS transmission in cell #2 is canceled due to a collision with high-priority uplink transmission. For SRS for positioning with bandwidth aggregation, UE may still maintain phase continuity and/or power consistency across cell #0 and cell #1.

In some other aspects, when configured by higher layers for transmission of SRS for positioning with bandwidth aggregation, there may be guard PRBs causing gaps in the frequency domain between two adjacent intra-band contiguous component carriers, and a UE may be expected to maintain phase continuity and/or power consistency as long as the number of guard PRBs is no larger than ‘N’. The value of ‘N’ may be defined as a function of subcarrier spacing (SCS) or determined based on an absolute guard band size (e.g., in MHz). Additionally, or alternatively, the value(s) of ‘N’ may be reported as UE capability from a list of candidate values.

A system and method of wireless communication for a 5G, NR, or beyond system includes configuring, by a base station (e.g., gNodeB), more than one sounding reference signal (SRS) resource set across intra-band contiguous carriers. The UE may transmit SRS across the intra-band contiguous carriers in accordance with the configured more than one SRS resource set.

In some aspects, reception of downlink positioning reference signal (DL PRS) with bandwidth aggregation may be configured to a UE indicating support of the features of DL carrier aggregation (CA) and bandwidth aggregation for DL PRS.

In some aspects, for DL PRS, whether bandwidth aggregation across intra-band contiguous carriers is enabled or disabled can be configured as part of NR-DL PRS-PositioningFrequencyLayer, NR-DL PRS-ResourceSet, or NR-DL PRS-Resource or as a separate higher layer parameter

In some aspects, for DL PRS with bandwidth aggregation, the UE may expect phase continuity and power consistency for DL PRS transmissions across intra-band contiguous carriers.

In some aspects, for DL PRS with bandwidth aggregation, the UE may expect the same configuration of measurement gap and/or PRS Processing Window across intra-band contiguous carriers.

In some aspects, for DL PRS with bandwidth aggregation, the UE may expect same time domain resource configuration and QCL assumption for DL PRS transmission across intra-band contiguous carriers.

In some aspects, an association between the DL PRS frequency layer in a first carrier and the DL PRS frequency layer in a second carrier can be defined and configured by higher layers via RRC signaling for DL PRS with bandwidth aggregation. In some aspects, when the DL PRS frequency layer in the first carrier is configured for DL PRS with bandwidth aggregation, the DL PRS frequency layer in the second carrier is also configured in accordance with the association.

In some aspects, the transmission of SRS for positioning with bandwidth aggregation may be configured to a UE, indicating support of the features of UL CA and bandwidth aggregation for SRS for positioning.

In some embodiments, for SRS for positioning, whether bandwidth aggregation across intra-band contiguous carriers is enabled or disabled can be configured as part of SRS-PosResourceSet configuration or as a separate higher layer parameter

In some aspects, SRS for positioning with bandwidth aggregation, an SRS resource set for positioning may be configured with a set of carrier and bandwidth part (BWP) indexes

In some aspects, for SRS for positioning with bandwidth aggregation, an SRS resource set may be configured with more than one SRS resource, where each SRS resource is associated with a carrier and BWP in the carrier.

In some aspects, an association between the SRS resource set for positioning in a first carrier and the SRS resource set for positioning in a second carrier can be defined and configured by higher layers via RRC signaling for SRS with bandwidth aggregation.

In some aspects, for SRS for positioning with bandwidth aggregation, an SRS resource set may include more than one SRS resource group, where each SRS resource group is associated with a carrier and a BWP in the carrier.

In some aspects, for semi-persistent SRS for positioning with bandwidth aggregation, more than one SRS resource sets across intra-band contiguous carriers may be activated or deactivated via Medium Access Control-Control Element (MAC-CE).

In some aspects, for aperiodic SRS transmission for positioning with bandwidth aggregation, a joint SRS request field can be included in the DCI for triggering SRS transmissions in multiple CCs simultaneously.

In some aspects, more than one set of serving cells and/or associated BWPs in the serving cell may be configured by higher layers via RRC signaling. In some aspects, a code point of the SRS request field in the DCI may be used to indicate one of the more than one set of serving cells and/or associated BWPs are used for SRS transmission for positioning.

In some aspects, to differentiate the SRS request for positioning with bandwidth aggregation and the SRS request for other purpose, one bit field may be included in the DCI format 0_1, 0_2, 1_1, 1_2, and/or the DCI format for multi-cell scheduling.

In some aspects, a group common DCI may be defined to trigger SRS transmission for positioning with bandwidth aggregation.

In some aspects, s-carrier scheduling or triggering of SRS for positioning using single or multiple DCI formats or single or multiple MAC CEs in a scheduling cell may be configured to a UE that indicates support of cross-carrier scheduling for carrier aggregation.

In some aspects, when configured by higher layers for transmission of SRS for positioning with bandwidth aggregation, the UE may receive the activation and/or deactivation command of SRS resource sets across intra-band contiguous carriers from different PDCCHs.

In some aspects, for SRS for positioning with bandwidth aggregation, UE may receive the activation and/or deactivation command of SRS resource sets across intra-band contiguous carriers from different PDCCHs (e.g., per CC).

In some aspects, the UE may need to maintain phase continuity and/or power consistency for simultaneous transmission of SRSs for positioning across intra-band contiguous carriers.

In some aspects, events that cause phase continuity and/or power consistency not to be maintained across SRS transmissions for positioning in intra-band contiguous carriers can be defined as a dropping or cancellation of an SRS transmission in a carrier in accordance with Clause 11.1 in TS 38.213 and Clause 6.2.1 in TS38.214.

In some aspects, for DL PRS bandwidth aggregation, the UE may assume that a DL PRS resource in the same symbol(s) in different carriers has the same QCL assumption with a reference signal from a reference carrier.

In some aspects, for DL PRS bandwidth aggregation, if the DL PRS resources in the same symbol(s) in different carriers/cells are each quasi-co-located (QCL′ed) with a reference signal for the respective carrier/cell, the UE may assume that the reference signals from different carriers/cells have same QCL assumption.

In some aspects, the UE determines the transmit power for SRS transmission in a reference BWP and/or carrier based on the pathloss measurement and a set of power control parameters in the reference BWP and/or cell.

In some aspects, the UE measures the DL pathloss for SRS transmission in a reference BWP and/or carrier and applies the measured pathloss from the reference BWP and/or carrier to determine transmit power for SRS transmission in other BWP and/or carriers for SRS with bandwidth aggregation.

In some aspects, for SRS for positioning with bandwidth aggregation, UE may assume that an SRS resource in the same symbol(s) in different carriers has the same spatial relation with other reference signal from a reference carrier.

In some aspects, for SRS for positioning with bandwidth aggregation, if a UE is configured with an SRS resource in the same symbol(s) in different carriers, each with spatial relation to a reference signal for the respective carrier, the UE may assume that the reference signals from different cells have same QCL assumption.

In some aspects, the same reference signal for pathloss calculation for each carrier can be configured for SRS transmission across contiguous carriers.

In some aspects, when the total transmit power for SRS transmission and other physical uplink channels/signals (if any) exceeds the maximum transmit power that is configured for a UE, the UE may cancel the SRS transmission in one or more carriers until the total transmit power does not exceed the maximum transmit power.

In some aspects, the one or more carriers may be determined based on the carrier index for SRS for positioning with bandwidth aggregation.

In some aspects, when the total transmit power for SRS transmission and other physical uplink channels/signals (if any) exceeds the maximum transmit power that is configured for a UE, the UE may cancel the SRS transmissions in all the carriers configured for SRS bandwidth aggregation.

In some aspects, when the total transmit power for SRS transmission across intra-band contiguous carriers exceeds the maximum transmit power that is configured for a UE, a scaling factor may be applied for the transmit power of SRS transmission in each carrier so that the total transmit power does not exceed the maximum transmit power.

In some aspects, the same resource type is needed to enable SRS for positioning with bandwidth aggregation.

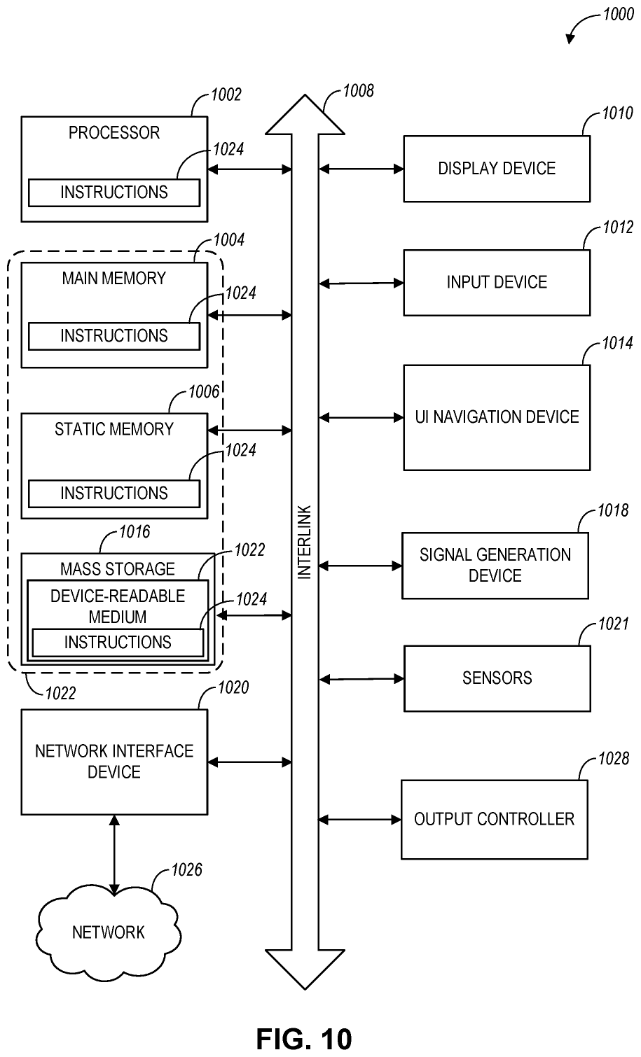

FIG. 10 illustrates a block diagram of a communication device such as an evolved Node-B (eNB), a new generation Node-B (gNB) (or another RAN node such as a base station), a network-controlled repeater (NCR), an access point (AP), a wireless station (STA), a mobile station (MS), or user equipment (UE), in accordance with some aspects and to perform one or more of the techniques disclosed herein. In alternative aspects, the communication device 1000 may operate as a standalone device or may be connected (e.g., networked) to other communication devices.

Circuitry (e.g., processing circuitry) is a collection of circuits implemented in tangible entities of the device 1000 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in the first circuit of a first circuitry at one point in time and reused by a second circuit in the first circuitry, or by a third circuit in a second circuitry at a different time. Additional examples of these components with respect to the device 1000 follow.

In some aspects, the device 1000 may operate as a standalone device or may be connected (e.g., networked) to other devices. In a networked deployment, the communication device 1000 may operate in the capacity of a server communication device, a client communication device, or both in server-client network environments. In an example, the communication device 1000 may act as a peer communication device in a peer-to-peer (P2P) (or other distributed) network environment. The communication device 1000 may be a UE, eNB, PC, a tablet PC, STB, PDA, mobile telephone, smartphone, a web appliance, network router, a switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules needs not to be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 1000 may include a hardware processor 1002 (e.g., a central processing unit (CPU), a graphics processing unit (GPU), a hardware processor core, or any combination thereof), a main memory 1004, a static memory 1006, and a storage device 1016 (e.g., hard drive, tape drive, flash storage, or other block or storage devices), some or all of which may communicate with each other via an interlink 1008 (e.g., a bus).

The communication device 1000 may further include a display device 1010, an input device 1012 (e.g., a keyboard), and a user interface (UI) navigation device 1014 (e.g., a mouse). In an example, the display device 1010, input device 1012, and UI navigation device 1014 may be a touchscreen display. The communication device 1000 may additionally include a signal generation device 1018 (e.g., a speaker), a network interface device 1020, and one or more sensors 1021, such as a global positioning system (GPS) sensor, compass, accelerometer, or another sensor. The communication device 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1016 may include a device-readable medium 1022, on which is stored one or more sets of data structures or instructions 1024 (e.g., software) embodying or utilized by any one or more of the techniques or functions described herein. In some aspects, registers of the hardware processor 1002, the main memory 1004, the static memory 1006, and/or the storage device 1016 may be, or include (entirely or at least partially), the device-readable medium 1022, on which is stored the one or more sets of data structures or instructions 1024, embodying or utilized by any one or more of the techniques or functions described herein. In an example, one or any combination of the hardware processor 1002, the main memory 1004, the static memory 1006, or the storage device 1016 may constitute the device-readable medium 1022.

As used herein, the term “device-readable medium” is interchangeable with “computer-readable medium” or “machine-readable medium”. While the device-readable medium 1022 is illustrated as a single medium, the term “communication device-readable medium” may include a single medium or multiple media (e.g., a centralized or distributed database and/or associated caches and servers) configured to store the instructions 1024. The term “communication device-readable medium” is inclusive of the terms “machine-readable medium” or “computer-readable medium” and may include any medium that is capable of storing, encoding, or carrying instructions (e.g., instructions 1024) for execution by the communication device 1000 and that causes the communication device 1000 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

Instructions 1024 may further be transmitted or received over a communications network 1026 using a transmission medium via the network interface device 1020 utilizing any one of several transfer protocols. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of the single-input-multiple-output (SIMO), MIMO, or multiple-input-single-output (MISO) techniques. In some examples, the network interface device 1020 may wirelessly communicate using Multiple User MIMO techniques.

The term “transmission medium” shall be taken to include any intangible medium that is capable of storing, encoding, or carrying instructions for execution by the communication device 1000 and includes digital or analog communications signals or another intangible medium to facilitate communication of such software. In this regard, a transmission medium in the context of this disclosure is a device-readable medium.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Described implementations of the subject matter can include one or more features, alone or in combination, as illustrated below by way of examples.

Example 1 is an apparatus for user equipment (UE) configured for operation in a Fifth Generation New Radio (5G NR) and beyond network, the apparatus comprising: processing circuitry, wherein to configure the UE for positioning enhancements in the 5G NR and beyond network, the processing circuitry is to: encode radio resource control (RRC) signaling for transmission to a base station using a physical uplink shared channel (PUSCH), the RRC signaling including UE capability information indicating the UE supports DL positioning reference signal (PRS) bandwidth aggregation; decode higher layer configuration via Radio Resource Control (RRC) signalling received from the base station, the higher layer configuration configuring a linkage between DL PRS resource sets across two or more downlink (DL) positioning frequency layers (PFLs) that are mapped to two or more contiguous intra-band DL component carriers for DL PRS bandwidth aggregation operation; perform measurements using the DL resource sets across the two or more contiguous intra-band DL component carriers in accordance with the linkage received from the base station, the DL PRS being bandwidth aggregated across the two or more contiguous intra-band DL component carriers based on the UE capability information indicating the UE supports DL PRS bandwidth aggregation; and a memory coupled to the processing circuitry and configured to store the DL PRS.

In Example 2, the subject matter of Example 1 includes subject matter where, for two DL PRS resource sets configured for bandwidth aggregation, a first DL PRS within a first DL PRS resource set that is mapped to a first DL PFL and a second DL PRS within a second DL PRS resource set that is mapped to a second DL PFL are provided with a same time domain resource configuration and quasi-co-location (QCL) assumption.

In Example 3, the subject matter of Example 2 includes subject matter where the same time domain resource configuration includes the same values of the higher layer parameters dl-PRS-Periodicity-and-ResourceSetSlotOffset, dl-PRS-NumSymbols, dl-PRS-ResourceTimeGap, dl-PRS-ResourceRepetitionFactor, dl-PRS-ResourceSymbolOffset, dl-prs-MutingBitRepetitionFactor, and dl-PRS-CyclicPrefix.

In Example 4, the subject matter of Examples 1-3 includes subject matter where the first DL PRS and the second DL PRS are assumed to be transmitted with phase continuity across the set of aggregated DL PFLs.

In Example 5, the subject matter of Examples 1-4 includes transceiver circuitry coupled to the processing circuitry; and one or more antennas coupled to the transceiver circuitry.

Example 6 is a computer-readable storage medium that stores instructions for execution by one or more processors of a base station, the instructions to configure the base station for communication with user equipment (UE) in a Fifth Generation New Radio (5G NR) and beyond network, and to cause the base station to perform operations comprising: decoding radio resource control (RRC) signaling received from the UE in a physical uplink shared channel (PUSCH), the RRC signaling including UE capability information indicating the UE supports UL sounding reference signal (UL SRS) for positioning bandwidth aggregation; encoding configuration signaling for transmission to the UE, the configuration signaling to configure a linkage between two or more UL SRS resource sets for positioning across two or more (respectively) contiguous intra-band uplink (UL) component carriers for bandwidth aggregation operation; and performing positioning measurements on uplink sounding reference signal (UL SRS) for positioning received from the UE in accordance with the configured linkage for UL SRS for positioning with bandwidth aggregation across the two or more contiguous intra-band UL component carriers.

In Example 7, the subject matter of Example 6 includes, the operations further comprising: decoding radio resource control (RRC) signaling received from the UE in a physical uplink shared channel (PUSCH), the RRC signaling including UE capability information indicating the UE supports DL positioning reference signal (PRS) bandwidth aggregation; encoding higher layer configuration via Radio Resource Control (RRC) signalling for transmission to the UE, the higher layer configuration configuring a linkage between DL PRS resource sets across two or more downlink (DL) positioning frequency layers (PFLs) that are mapped to two or more contiguous intra-band downlink (DL) component carriers for DL PRS bandwidth aggregation operation; and encoding DL PRS resource sets across the two or more contiguous intra-band DL component carriers in accordance with the linkage for transmission to the UE, the DL PRS being bandwidth aggregated across the two or more contiguous intra-band DL component carriers based on the UE capability information indicating the UE supports DL PRS bandwidth aggregation.

In Example 8, the subject matter of Example 7 includes subject matter where, for two DL PRS resource sets configured for bandwidth aggregation, a first DL PRS within a first DL PRS resource set that is mapped to a first DL PFL and a second DL PRS within a second DL PRS resource set that is mapped to a second DL PFL are provided with a same time domain resource configuration and quasi-co-location (QCL) assumption.

In Example 9, the subject matter of Example 8 includes subject matter where the same time domain resource configuration includes the same values of the higher layer parameters dl-PRS-Periodicity-and-ResourceSetSlotOffset, dl-PRS-NumSymbols, dl-PRS-ResourceTimeGap, dl-PRS-ResourceRepetitionFactor, dl-PRS-ResourceSymbolOffset, dl-prs-MutingBitRepetitionFactor, and dl-PRS-CyclicPrefix.

In Example 10, the subject matter of Examples 7-9 includes subject matter where the first DL PRS and the second DL PRS are assumed to be transmitted with phase continuity across the set of aggregated DL PFLs.

Example 11 is a computer-readable storage medium that stores instructions for execution by one or more processors of a user equipment (UE), the instructions to configure the UE for positioning enhancements in a Fifth Generation New Radio (5G NR) and beyond network, and to cause the UE to perform operations comprising: encoding radio resource control (RRC) signaling for transmission to a base station using a physical uplink shared channel (PUSCH), the RRC signaling including UE capability information indicating the UE supports UL SRS for positioning bandwidth aggregation; decoding higher layer configuration via Radio Resource Control (RRC) signalling from the base station, the higher layer configuration configuring a linkage between UL SRS resource sets for positioning across two or more contiguous intra-band uplink (UL) component carriers for UL SRS bandwidth aggregation operation; and transmitting the UL SRS resource sets across the two or more contiguous intra-band UL component carriers in accordance with the linkage received from the base station using the set of contiguous intra-band UL component carriers.

In Example 12, the subject matter of Example 11 includes subject matter where, for two UL SRS for positioning resource sets configured for bandwidth aggregation, a first UL SRS for positioning within a first UL SRS resource set for positioning that is mapped to a first UL carrier and a second UL SRS for positioning within a second UL SRS resource set for positioning that is mapped to a second UL carrier are provided with a same time domain resource configuration and quasi-co-location (QCL) assumption across the set of contiguous intra-band UL component carriers.

In Example 13, the subject matter of Example 12 includes subject matter where the same time domain resource configuration includes the same values of at least the higher layer parameters startPosition, nrofSymbols, periodicity AndOffset, slotOffset, and same values of subcarrier spacing (SCS), and cyclic prefix (CP).

In Example 14, the subject matter of Examples 11-13 includes subject matter where the first UL SRS resource set for positioning and the second UL SRS resource set for positioning that are linked for bandwidth aggregation are transmitted while maintaining phase continuity across the set of contiguous intra-band UL component carriers.

In Example 15, the subject matter of Examples 11-14 includes subject matter where the first UL SRS resource set for positioning and the second UL SRS resource set for positioning that are linked for bandwidth aggregation are configured with the same UL SRS resource type that may be one of periodic, semi-persistent or aperiodic.

In Example 16, the subject matter of Examples 11-15 includes subject matter where, for semi-persistent UL SRS resource sets for positioning that are linked for bandwidth aggregation, a single activation and deactivation command from medium access control-control element (MAC-CE) applies to the two or more UL SRS resource sets for positioning across the two or more contiguous intra-band UL component carriers.

In Example 17, the subject matter of Examples 11-16 includes subject matter where, for aperiodic UL SRS resource sets for positioning that are linked for bandwidth aggregation, if the UE receives a downlink control information (DCI) format with an SRS request bit-field triggering an aperiodic SRS resource set for positioning linked for bandwidth aggregation in a UL carrier, the SRS request bit-field indicates a joint triggering across the linked UL SRS resource sets for positioning and the UE transmits SRS of the linked SRS resource sets across all contiguous intra-band UL carriers.

In Example 18, the subject matter of Examples 11-17 includes subject matter where the UE applies the same values of DL pathloss reference, open loop power control parameter P0, and fractional pathloss compensation parameter alpha for all SRS for positioning transmissions across the two or more contiguous intra-band UL component carriers that are linked for SRS for positioning bandwidth aggregation.

In Example 19, the subject matter of Examples 11-18 includes subject matter where the UE transmits SRS for positioning across the two or more contiguous intra-band UL component carriers that are linked for SRS for positioning bandwidth aggregation with the same transmission power per resource element (RE) of the SRS for positioning.

In Example 20, the subject matter of Examples 11-19 includes subject matter where, for two DL PRS resource sets configured for bandwidth aggregation, a first DL PRS within a first DL PRS resource set that is mapped to a first DL positioning frequency layer (PFL) and a second DL PRS within a second DL PRS resource set that is mapped to a second DL PFL are provided with a same time domain resource configuration and quasi-co-location (QCL) assumption.

Example 21 is at least one machine-readable medium including instructions that, when executed by processing circuitry, cause the processing circuitry to perform operations to implement any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an aspect has been described concerning specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

1-20. (canceled)

21. An apparatus for a user equipment (UE) configured for operation in a New Radio (NR) network, the apparatus comprising:
processing circuitry, wherein to configure the UE for bandwidth aggregation for positioning in the NR network, the processing circuitry is to:
encode a UE capability information element (IE) for transmission to a base station, the UE capability IE indicating that the UE supports bandwidth aggregation for sounding reference signal (SRS) positioning;
decode radio resource control (RRC) signaling received from the base station in response to the UE capability IE, the RRC signaling to identify SRS positioning resource sets linked across at least two component carriers (CCs) for bandwidth aggregation;
decode a downlink control information (DCI) format received from the base station, the DCI format triggering one of the SRS positioning resource sets associated with a CC of the at least two CCs; and
encode a SRS of the SRS positioning resource set for transmission across the at least two CCs; and
memory coupled to the processing circuitry and configured to store the RRC signaling and the DCI format.

22. The apparatus of claim 21, wherein the transmission of the SRS is associated with a same time domain resource allocation across the at least two CCs, the same time domain resource allocation including a same symbol and slot index.

23. The apparatus of claim 21, wherein the UE is configured to maintain phase continuity for simultaneous transmission of SRSs across the at least two CCs.

24. The apparatus of claim 21, wherein the processing circuitry is to:
decode a medium access control control element (MAC CE), the MAC CE including an activation command activating the SRS positioning resource sets across the at least two CCs.

25. The apparatus of claim 21, wherein the DCI format is one of DCI format 0_1, DCI format 0_2, DCI format 1_1, or DCI format 1_2.

26. The apparatus of claim 21, wherein the processing circuitry is to:
decode configuration signaling, the configuration signaling to configure the UE to perform aggregated measurements for bandwidth aggregation between downlink positioning reference signal (DL PRS) resource sets across DL PRS positioning frequency layers.

27. The apparatus of claim 26, wherein the UE performs the aggregated measurements based on a same phase continuity associated with the DL PRS resource sets.

28. The apparatus of claim 21, further comprising:
transceiver circuitry coupled to the processing circuitry; and
one or more antennas comprising multiple antenna panels, the one or more antennas coupled to the transceiver circuitry.

29. A non-transitory computer-readable storage medium that stores instructions for execution by one or more processors of a user equipment (UE), the instructions to configure the UE for bandwidth aggregation for positioning in a New Radio (NR) network, and to cause the UE to perform operations comprising:
encoding a UE capability information element (IE) for transmission to a base station, the UE capability IE indicating that the UE supports bandwidth aggregation for sounding reference signal (SRS) positioning;
decoding radio resource control (RRC) signaling received from the base station in response to the UE capability IE, the RRC signaling to identify SRS positioning resource sets linked across at least two component carriers (CCs) for bandwidth aggregation;
decoding a downlink control information (DCI) format received from the base station, the DCI format triggering one of the SRS positioning resource sets associated with a CC of the at least two CCs; and
encoding a SRS of the SRS positioning resource set for transmission across the at least two CCs.

30. The non-transitory computer-readable storage medium of claim 29, wherein the transmission of the SRS is associated with a same time domain resource allocation across the at least two CCs, the same time domain resource allocation including a same symbol and slot index.

31. The non-transitory computer-readable storage medium of claim 29, wherein the UE is configured to maintain phase continuity for simultaneous transmission of SRSs across the at least two CCs.

32. The non-transitory computer-readable storage medium of claim 29, the operations comprising:
decoding a medium access control control element (MAC CE), the MAC CE including an activation command activating the SRS positioning resource sets across the at least two CCs.

33. The non-transitory computer-readable storage medium of claim 29, wherein the DCI format is one of DCI format 0_1, DCI format 0_2, DCI format 1_1, or DCI format 1_2.

34. The non-transitory computer-readable storage medium of claim 29, the operations comprising:
decoding configuration signaling, the configuration signaling to configure the UE to perform aggregated measurements for bandwidth aggregation between downlink positioning reference signal (DL PRS) resource sets across DL PRS positioning frequency layers.

35. The non-transitory computer-readable storage medium of claim 34, wherein the UE performs the aggregated measurements based on a same phase continuity associated with the DL PRS resource sets.

36. A user equipment (UE) configured for operation in a New Radio (NR) network, the UE comprising:
front-end circuitry coupled to one or more antennas;
processing circuitry coupled to the front-end circuitry, wherein to configure the UE for bandwidth aggregation for positioning in the NR network, the processing circuitry is to: encode a UE capability information element (IE) for transmission to a base station, the UE capability IE indicating that the UE supports bandwidth aggregation for sounding reference signal (SRS) positioning;
decode radio resource control (RRC) signaling received from the base station in response to the UE capability IE, the RRC signaling to identify SRS positioning resource sets linked across at least two component carriers (CCs) for bandwidth aggregation;
decode a downlink control information (DCI) format received from the base station, the DCI format triggering one of the SRS positioning resource sets associated with a CC of the at least two CCs; and
encode a SRS of the SRS positioning resource set for transmission across the at least two CCs.

37. The UE of claim 36, wherein the transmission of the SRS is associated with a same time domain resource allocation across the at least two CCs, the same time domain resource allocation including a same symbol and slot index.

38. The UE of claim 36, wherein the UE is configured to maintain phase continuity for simultaneous transmission of SRSs across the at least two CCs.

39. The UE of claim 36, wherein the processing circuitry is to:
decode a medium access control control element (MAC CE), the MAC CE including an activation command activating the SRS positioning resource sets across the at least two CCs.

40. The UE of claim 36, wherein the DCI format is one of DCI format 0_1, DCI format 0_2, DCI format 1_1, or DCI format 1_2.

41. The UE of claim 36, wherein the processing circuitry is to:
decode configuration signaling, the configuration signaling to configure the UE to perform aggregated measurements for bandwidth aggregation between downlink positioning reference signal (DL PRS) resource sets across DL PRS positioning frequency layers.

42. The UE of claim 41, wherein the UE performs the aggregated measurements based on a same phase continuity associated with the DL PRS resource sets.
